(19) United States
(12) Patent Application Publication
(10) Pub. No.: US 2008/0213638 A1
(43) Pub. Date: Sep. 4, 2008

(54) ENGINE BLOCK FOR USE IN A FUEL CELL SYSTEM

(75) Inventors: Jennifer Brantley, Dublin, CA (US); Kenneth Newell, Livermore, CA (US); James L. Kaschmitter, Pleasanton, CA (US); David Sopchak, Oakland, CA (US); Ian W. Kaye, Livermore, CA (US); Arpad Somogyvari, Livermore, CA (US); Lucie Bednarova, Livermore, CA (US); Michael C. DeRenzi, San Ramon, CA (US)

Correspondence Address: Beyer Law Group LLP, P.O. BOX 1687, Cupertino, CA, 95015-1687, US

(73) Assignee: ULTRACELL CORPORATION, Livermore, CA (US)

(21) Appl. No.: 11/834,587

(22) Filed: Aug. 6, 2007

Related U.S. Application Data
(60) Provisional application No. 60/836,896, filed on Aug. 9, 2006.
(60) Provisional application No. 60/836,859, filed on Aug. 9, 2006.

(51) Int. Cl. H01M 8/06; H01M 8/04; H01M 8/00

(52) U.S. Cl. 429/19; 429/36; 429/26; 29/623.1

(57) ABSTRACT

In one embodiment, an engine block may comprise an interconnect having: a first manifold section, a second manifold section perpendicular to the first manifold section, the first manifold section and the second manifold section having a plurality of conduits to receive a gas flow, wherein the first manifold section and the second manifold section are formed from a single manifold device; a fuel cell stack housing coupled to the second manifold section to receive a fuel cell stack; and a fuel processor coupled to the first manifold section, wherein the fuel cell processor and the fuel cell stack operate at substantially the same temperature.

### CROSS REFERENCE TO RELATED APPLICATIONS

This application claims priority under 35 U.S.C. §119(e) to U.S. Provisional Patent Application No. 60/836,896, filed on Aug. 9, 2006 entitled “PORTABLE FUEL CELL SYSTEMS”, which is incorporated by reference for all purposes.

This application also claims priority under 35 U.S.C. § 119(e) to U.S. Provisional Patent Application No. 60/836,859, filed on Aug. 9, 2006 entitled “FUEL PROCESSOR FOR USE IN A FUEL CELL SYSTEM”, which is incorporated by reference for all purposes.

### FIELD OF THE INVENTION

The present disclosure relates generally to fuel cell technology. In particular, the invention relates to an engine block, used in a fuel cell system, to convert hydrogen to electrical energy.

### BACKGROUND OF THE INVENTION

A fuel cell electrochemically combines hydrogen and oxygen to generate electrical energy. Fuel cell development so far has only serviced large-scale applications such as industrial size generators for electrical power back up. Consumer electronics devices and other portable electrical power applications currently rely on lithium ion and similar battery technologies. Fuel cell systems that generate electrical energy for portable applications such as electronics would be desirable. In addition, technology advances that reduce fuel cell system size and increase the manufacturability of the fuel cell system would be beneficial.

Current fuel cell systems are typically composed of a plurality of individual reactors, electrochemical devices, instrumentation, power input and output wiring, and plumbing. While each individual component is relatively easy to assemble and test, assembling and testing a complete fuel cell system requires an excessive amount of bulky packaging and manual labor, resulting in a large and expensive to produce system. Additionally, the fuel cell system balance of plant components are often a cost or reliability barrier, and hence must be selected based on the end user of the fuel cell system. Therefore a means of combining all the core power generation components into a single package is desired in order to reduce the size and complexity of the fuel cell system, while allowing maximum flexibility to select the optimal balance of plant components for the specific end user.

Furthermore, current fuel cell stacks are assembled or sealed with the use of gaskets and/or fasteners, such as screws. These joints are susceptible to degradation, relaxation, or creep at high temperatures in a short amount of time which may result in leaks and degradation. Additionally, these joints result in added materials and assembly of the fuel cell system is not conducive to high volume manufacturing or automation.

### Overview

The present disclosure relates an engine block, used in a fuel cell system, to convert hydrogen to electrical energy. The engine block may have a fuel processor and a fuel cell stack in fluid communication via an interconnect or an engine block base, both having a plurality of conduits or fluid passageways therein. The engine block may also have an efficient fuel cell stack heater to improve the efficiency of the fuel cell system.

In one embodiment, an engine block may comprise an interconnect having: a first manifold section, a second manifold section perpendicular to the first manifold section, the first manifold section and the second manifold section having a plurality of conduits to receive a gas flow, wherein the first manifold section and the second manifold section are formed from a single manifold device, a fuel cell stack housing coupled to the second manifold section to receive a fuel cell stack, and a fuel processor coupled to the first manifold section, wherein the fuel cell processor and the fuel cell stack operate at substantially the same temperature.

In another embodiment, an engine block may have an engine block base formed from a single plate having: a top surface, a bottom surface, the top surface having a first end, and a second end, a plurality of fluid passageways formed in the top surface and the bottom surface, a fuel cell stack permanently sealed to the second end, and a fuel processor permanently sealed to the first end, wherein the fuel cell stack and the fuel processor are in fluid communication via the plurality of fluid passageways.

In yet another embodiment, a method for manufacturing an engine block, comprises forming an interconnect having a plurality of conduits, each conduit configured to receive a gas flow, the interconnect having a first end substantially perpendicular to a second end; attaching a fuel processor to a first end of the interconnect, the fuel processor having a plurality of ports aligned with at least one of the plurality of conduits; and attaching a fuel cell stack housing to a second end of the interconnect, the housing configured to receive a fuel cell stack, the fuel cell stack having a plurality of ports aligned with at least one of the plurality of conduits, wherein the fuel processor and the fuel cells stack operate at substantially the same temperature.

In still another embodiment, a method for manufacturing an engine block may comprise forming a single engine block base having a top surface and a bottom surface, the top surface having a first end and a second end, creating a plurality of fluid passageways on the top surface and the bottom surface, permanently attaching the plurality of fluid passageways with a top cover on the top surface and a bottom cover on the bottom surface, permanently attaching a fuel processor to the first end of the engine block, the fuel processor having a plurality of fuel processor components, and permanently attaching a fuel cell stack to the second end of the engine block, wherein a plurality of ports on the fuel processor align with at least one of the plurality of fluid passageways, and wherein a plurality of ports on the fuel cell stack align with at least one of the plurality of fluid passageways such that the fuel processor and the fuel cell stack are in fluid communication.

In another embodiment, an engine block may have a fuel cell stack having at least one fuel inlet, a fuel processor in fluid communication with the fuel cell stack, the fuel processor having at least one fuel inlet, at least one fuel cell heater (power generating portion) coupled to the fuel cell stack, at least one thermocouple coupled to the fuel cell stack and fuel processor, and at least one power input/output leads coupled to the fuel cell stack.

These and other features will be presented in more detail in the following detailed description of the invention and the associated figures.

### BRIEF DESCRIPTION OF THE DRAWINGS

The accompanying drawings, which are incorporated into and constitute a part of this specification, illustrate one or more example embodiments and, together with the description of example embodiments, serve to explain the principles and implementations.

In the drawings:

FIGS. 1A and 1B illustrate an example fuel cell system and a schematic operation of the fuel cell system.

FIGS. 2A-2D illustrate an example fuel cell.

FIGS. 3A and 3B illustrate an example fuel processor

FIGS. 4A-4G illustrate an example interconnect.

FIG. 5 illustrates a top view of an example engine block.

FIG. 6 illustrates an example fuel cell stack heater.

FIG. 7 is a graph of fuel cell stack heating rates.

FIGS. 8A-8D illustrate an example fuel cell system assembly.

FIGS. 9A-9H illustrate an example fuel cell system assembly.

FIGS. 10A and 10B illustrate example methods for manufacturing an engine block.

### DESCRIPTION OF EXAMPLE EMBODIMENTS

Embodiments are described herein in the context of an engine block for use in a fuel cell system. The following detailed description is illustrative only and is not intended to be in any way limiting. Other embodiments will readily suggest themselves to such skilled persons having the benefit of this disclosure. Reference will now be made in detail to implementations as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

Fuel Cell System Overview

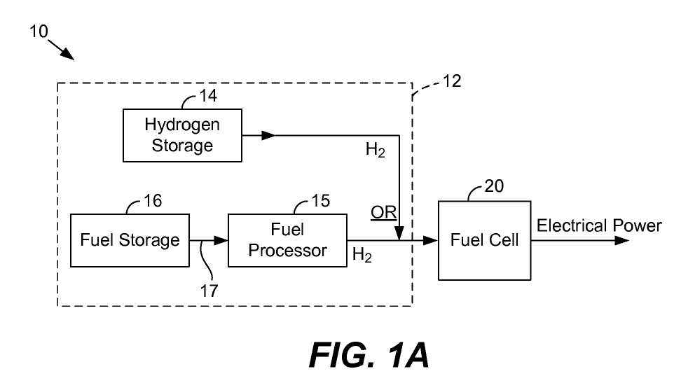

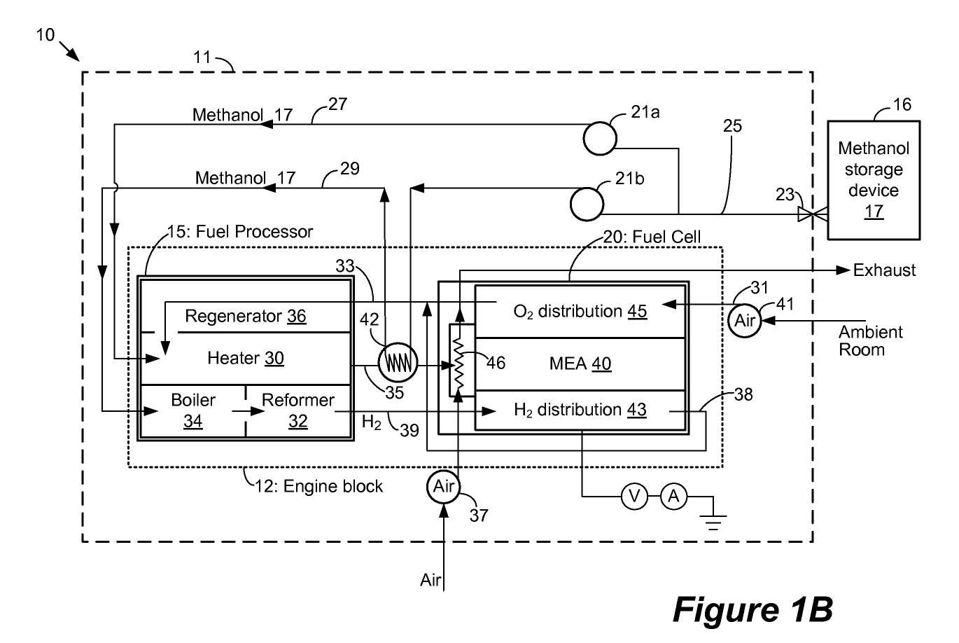

FIGS. 1A and 1B illustrate an example fuel cell system and a schematic operation of the fuel cell system. Fuel cell systems that benefit from embodiments described herein will be described. FIG. 1A illustrates a fuel cell system 10 for producing electrical energy. As shown, ‘reformed’ hydrogen system 10 includes a fuel processor 15 and fuel cell 20, with a fuel storage device 16 coupled to system 10 for fuel provision. System 10 processes a fuel 17 to produce hydrogen for fuel cell 20.

Storage device, or cartridge, 16 stores a fuel 17, and may comprise a refillable and/or disposable device. Either design permits recharging capability for system 10 or an electronics device using the output electrical power by swapping a depleted cartridge for one with fuel. A connector on cartridge 16 interfaces with a mating connector on system 10 or the electronics device to permit fuel transfer from the cartridge. In a specific embodiment, cartridge 16 includes a bladder that contains the fuel 17 and conforms to the volume of fuel in the bladder. An outer rigid housing of device 16 provides mechanical protection for the bladder. The bladder and housing permit a wide range of cartridge sizes with fuel capacities ranging from a few milliliters to several liters. In one embodiment, the cartridge is vented and includes a small hole, single direction flow valve, hydrophobic filter, or other aperture to allow air to enter the fuel cartridge as fuel 17 is consumed and displaced from the cartridge. In another specific embodiment, the cartridge includes ‘smarts’, or a digital memory used to store information related to usage of device 16.

A pressure source moves fuel 17 from storage device 16 to fuel processor 15. In a specific embodiment, a pump in system 10 draws fuel from the storage device. Cartridge 16 may also be pressurized with a pressure source such as a compressible foam, spring, or a propellant internal to the housing that pushes on the bladder (e.g., propane or compressed nitrogen gas). In this case, a control valve in system 10 regulates fuel flow. Other fuel cartridge designs suitable for use herein may include a wick that moves a liquid fuel from within cartridge 16 to a cartridge exit. If system 10 is load following, then a sensor meters fuel delivery to processor 15, and a control system in communication with the sensor regulates the fuel flow rate as determined by a desired power level output of fuel cell 20.

Fuel 17 acts as a carrier for hydrogen and can be processed or manipulated to separate hydrogen. The terms ‘fuel’, ‘fuel source’ and ‘hydrogen fuel source’ are interchangeable herein and all refer to any fluid (liquid or gas) that can be manipulated to separate hydrogen. Liquid fuels 17 offer high energy densities and the ability to be readily stored and shipped. Fuel 17 may include any hydrogen bearing fuel stream, hydrocarbon fuel or other source of hydrogen such as ammonia. Currently available hydrocarbon fuels 17 suitable for use with system 10 include gasoline, C₁ to C₄ hydrocarbons, their oxygenated analogues and/or their combinations, for example. Other fuel sources may be used with system 10, such as sodium borohydride. Several hydrocarbon and ammonia products may also be used.

Fuel 17 may be stored as a fuel mixture. When the fuel processor 15 comprises a steam reformer, for example, storage device 16 includes a fuel mixture of a hydrocarbon fuel and water. Hydrocarbon fuel/water mixtures are frequently represented as a percentage of fuel in water. In one embodiment, fuel 17 comprises methanol or ethanol concentrations in water in the range of 1-99.9%. Other liquid fuels such as butane, propane, gasoline, military grade “JP8”, etc. may also be contained in storage device 16 with concentrations in water from 5-100%. In a specific embodiment, fuel 17 comprises 67% methanol by volume.

Fuel processor 15 receives methanol 17 and outputs hydrogen. In one embodiment, a hydrocarbon fuel processor 15 heats and processes a hydrocarbon fuel 17 in the presence of a catalyst to produce hydrogen. Fuel processor 15 comprises a reformer, which is a catalytic device that converts a liquid or gaseous hydrocarbon fuel 17 into hydrogen and carbon dioxide. As the term is used herein, reforming refers to the process of producing hydrogen from a fuel 17. Fuel processor 15 may output either pure hydrogen or a hydrogen bearing gas stream (also commonly referred to as ‘reformate’).

In another embodiment, hydrogen supply 12 provides hydrogen to fuel cell 20. As shown, supply 12 includes a hydrogen storage device 14 and/or a ‘reformed’ hydrogen supply. Fuel cell 20 typically receives hydrogen from one supply at a time, although fuel cell systems 10 that employ redundant hydrogen provision from multiple supplies are useful in some applications. Hydrogen storage device 14 outputs hydrogen, which may be a pure source such as compressed hydrogen held in a pressurized container 14. A solid-hydrogen storage system such as a metal-based hydrogen storage device known to those of skill in the art may also be used for hydrogen storage device 14.

Various types of reformers are suitable for use in fuel cell system 10; these include steam reformers, auto thermal reformers (ATR) and catalytic partial oxidizers (CPOX) for example. A steam reformer only needs steam and fuel to produce hydrogen. ATR and CPOX reformers mix air with a fuel/steam mixture. ATR and CPOX systems reform fuels such as methanol, diesel, regular unleaded gasoline and other hydrocarbons. In a specific embodiment, storage device 16 provides methanol 17 to fuel processor 15, which reforms the methanol at about 260 to 360 degrees Celsius or less, depending on the choice of copper zinc based reforming catalysts or palladium based reforming catalysts, and allows fuel cell system 10 usage in low temperature applications.

Fuel cell 20 electrochemically converts hydrogen and oxygen to water, generating electrical energy (and sometimes heat) in the process. Ambient air readily supplies oxygen. A pure or direct oxygen source may also be used. The water often forms as a vapor, depending on the temperature of fuel cell 20. For some fuel cells, the electrochemical reaction may also produce carbon dioxide as a byproduct.

In one embodiment, fuel cell 20 is a low volume ion conductive membrane (PEM) fuel cell suitable for use with portable applications and consumer electronics. A PEM fuel cell comprises a membrane electrode assembly (MEA) that carries out the electrical energy generating an electrochemical reaction. The MEA includes a hydrogen catalyst, an oxygen catalyst, and an ion conductive membrane that a) selectively conducts protons and b) electrically isolates the hydrogen catalyst from the oxygen catalyst. One suitable MEA is model number CELTEC P1000 as provided by BASF Fuel Cells of Frankfurt, Germany, which operate in the temperature range of approximately between about 140 to 180 degree Celsius. A hydrogen gas distribution layer may also be included; it contains the hydrogen catalyst and allows the diffusion of hydrogen therethrough. An oxygen gas distribution layer contains the oxygen catalyst and allows the diffusion of oxygen and hydrogen protons therethrough. Typically, the ion conductive membrane separates the hydrogen and oxygen gas distribution layers. In chemical terms, the anode comprises the hydrogen gas distribution layer and hydrogen catalyst, while the cathode comprises the oxygen gas distribution layer and oxygen catalyst.

In one embodiment, a PEM fuel cell includes a fuel cell stack having a set of bi-polar plates. In a specific embodiment, each bi-polar plate is formed from a thin single sheet of metal that includes channel fields on opposite surfaces of the metal sheet. Thickness for these plates is typically below about 5 millimeters, and compact fuel cells for portable applications may employ plates thinner than about 2 millimeters. The single bi-polar plate thus dually distributes hydrogen and oxygen; one channel field distributes hydrogen while a channel field on the opposite surface distributes oxygen. In another embodiment, each bi-polar plate is formed from multiple layers that include more than one sheet of metal. Multiple bi-polar plates can be stacked to produce the ‘fuel cell stack’ in which a membrane electrode assembly is disposed between each pair of adjacent bi-polar plates. Gaseous hydrogen distribution to the hydrogen gas distribution layer in the MEA occurs via a channel field on one plate while oxygen distribution to the oxygen gas distribution layer in the MES occurs via a channel field on a second plate on the other surface of the membrane electrode assembly.

In electrical terms, the anode includes the hydrogen gas distribution layer, hydrogen catalyst and a bi-polar plate. The anode acts as the negative electrode for fuel cell 20 and conducts electrons that are freed from hydrogen molecules so that they can be used externally, e.g., to power an external circuit or stored in a battery. In electrical terms, the cathode includes the oxygen gas distribution layer, oxygen catalyst and an adjacent bi-polar plate. The cathode represents the positive electrode for fuel cell 20 and conducts the electrons back from the external electrical circuit to the oxygen catalyst, where they can recombine with hydrogen ions and oxygen to form water.

In a fuel cell stack, the assembled bi-polar plates are connected in series to add electrical potential gained in each layer of the stack. The term ‘bi-polar’ refers electrically to a bi-polar plate (whether mechanically comprised of one plate or two plates) sandwiched between two membrane electrode assembly layers. In a stack where plates are connected in series, a bi-polar plate acts as both a negative terminal for one adjacent (e.g., above) membrane electrode assembly and a positive terminal for a second adjacent (e.g., below) membrane electrode assembly arranged on the opposite surface of the bi-polar plate.

In a PEM fuel cell, the hydrogen catalyst separates the hydrogen into protons and electrons. The ion conductive membrane blocks the electrons, and electrically isolates the chemical anode (hydrogen gas distribution layer and hydrogen catalyst) from the chemical cathode. The ion conductive membrane also selectively conducts positively charged ions. Electrically, the anode conducts electrons to a load (electrical energy is produced) or battery (energy is stored). Meanwhile, protons move through the ion conductive membrane. The protons and used electrons subsequently meet on the cathode side, and combine with oxygen to form water. The oxygen catalyst in the oxygen gas distribution layer facilitates this reaction. One common oxygen catalyst comprises platinum powder thinly coated onto a carbon paper or cloth. Many designs employ a rough and porous catalyst to increase surface area of the platinum exposed to the hydrogen and oxygen. A fuel cell suitable for use herein is further described in commonly owned patent application Ser. No. 11/120,643, entitled “Compact Fuel Cell Package”, which is incorporated by reference in its entirety for all purposes.

Since the electrical generation process in fuel cell 20 is exothermic, fuel cell 20 may implement a thermal management system to dissipate heat. Fuel cell 20 may also employ a number of humidification plates (HP) to manage moisture levels in the fuel cell.

While system 10 will mainly be discussed with respect to PEM fuel cells, it is understood that system 10 may be practiced with other fuel cell architectures. The main difference between fuel cell architectures is the type of ion conductive membrane used. In another embodiment, fuel cell 20 is phosphoric acid fuel cell that employs liquid phosphoric acid for ion exchange. Solid oxide fuel cells employ a hard, non-porous ceramic compound for ion exchange and may be suitable for use with embodiments described herein. Other suitable fuel cell architectures may include alkaline and molten carbonate fuel cells, for example.

FIG. 1B illustrates schematic operation for the fuel cell system 10 of FIG. 1A. Fuel cell system 10 is included in a portable package 11. In this case, package 11 includes fuel cell 20, fuel processor 15, and all other balance-of-plant components except cartridge 16. As the term is used herein, a fuel cell system package 11 refers to a fuel cell system that receives a fuel and outputs electrical energy. At a minimum, this includes a fuel cell and fuel processor. The package need not include a cover or housing, e.g., in the case where a fuel cell, or a fuel cell and fuel processor, is included in a battery bay of a laptop computer. In this case, the portable fuel cell system package 11 only includes the fuel cell, or fuel cell and fuel processor, and no housing. The package may include a compact profile, low volume, or low mass—any of which is useful in any power application where size is relevant.

Package 11 is divided into two parts: a) an engine block 12 and b) all other parts and components of system 10 in the portable package 11 not included in engine block 12. In one embodiment, engine block 12 includes the core power-producing mechanical components of system 10. At a minimum, this includes fuel processor 15 and fuel cell 20. It may also include any plumbing configured to transport fluids between the two. Other system components included in engine block 12 may include: one or more sensors for fuel processor 15 and fuel cell 20, a glow plug or electrical heater for fuel heating in fuel processor during start-up, and/or one or more cooling components. Engine block 12 may include other system components, such as sensors for measuring pressure, fuel or air flow, temperature or gas compositions and may also include thermal insulation. In one embodiment, the thermal insulation may surround or enclose the fuel cell stack and the fuel processor. In another embodiment, the thermal insulator may enclose the fuel cell stack, the fuel processor, and the at least one fuel cell heater.

Components outside of engine block 12 may include: a body for the package, connector 23, inlet and outlet plumbing for system fluids to or from fuel processor 15 or fuel cell 20, one or more compressors or fans, electronic controls, system pumps and valves, any system sensors, manifolds, heat exchangers and electrical interconnects useful for carrying out functionality of fuel cell system 10.

In one embodiment, the engine block 12 includes a fuel cell, a fuel processor, and dedicated mechanical and fluidic connectivity between the two. The dedicated connectivity may provide a) fluid or gas communication between the fuel processor and the fuel cell, and/or b) structural support between the two or for the package. In one embodiment, an interconnect, which is a separate device dedicated to interconnecting the two devices, provides much of the connectivity. In another embodiment, direct and dedicated connectivity is provided on the fuel cell and/or fuel processor to interface with the other. For example, a fuel cell may be designed to interface with a particular fuel processor and includes dedicated connectivity for that fuel processor. Alternatively, a fuel processor may be designed to interface with a particular fuel cell. Assembling the fuel processor and fuel cell together in a common and substantially enclosed package 11 provides a portable ‘black box’ device that receives a fuel and outputs electrical energy.

In one embodiment, system 10 may be sold as a physical engine block 12 plus specifications for interfacing with the engine block 12. The specifications may include desired cooling rates, airflow rates, physical sizing, heat capture and release information, plumbing specifications, fuel inlet parameters such as the fuel type, mixture and flow rates, etc. This permits engine block 12 to be sold as a core component employed in a wide variety of devices determined by the engine block purchaser. Additionally, this arrangement permits the purchaser to provide mission specific balance of plant components (i.e. fuel pumps, air compressors, fans and blowers, gas composition sensors, and the like). Gas composition sensors may be positioned to test the gas flows throughout the fuel cell system. For example, the gas composition sensor may be used to test exhaust gas flows, hydrogen gas flow, or any or gas or fluid flows in the fuel cell system.

In one example, one end user may desire long life over noise level, and therefore the purchaser can install an optimal air compressor for this application; other customers may prefer the lowest cost option, and therefore the purchaser can install the appropriate option. This offers significant flexibility to the purchaser, because a very broad spectrum of air compressors is available meeting different requirements. In another example, commercially available compressors with a cost of several dollars per unit are available, but they only last several hundred hours and are loud, whereas quiet and expensive compressors are available which last several thousand hours but cost several hundred dollars per unit. Hence the balance of plant components can be optimized for the device to be powered without having to change the engine block components. Sample devices include: portable fuel cell systems, consumer electronics components such as laptop computers, and custom electronics devices such as single or multiple unit battery chargers for radios and other communications devices.

Fuel storage device 16 stores methanol or a methanol mixture as a hydrogen fuel 17. An outlet of storage device 16 includes a connector 23 that couples to a mating connector on package 11. In a specific embodiment, connector 23 and mating connector form a quick connect/disconnect for easy replacement of cartridges 16. The mating connector communicates methanol 17 into hydrogen fuel line 25, which is internal to package 11.

Line 25 divides into two lines: a first line 27 that transports methanol 17 to a burner/heater 30 for fuel processor 15 and a second line 29 that transports methanol 17 for a reformer 32 in fuel processor 15. Lines 25, 27 and 29 may comprise channels disposed in the fuel processor (e.g., channels in one or more metal components) and/or tubes leading thereto.

As the term is used herein, a line refers to one or more conduits or channels that communicate a fluid (a gas, liquid, or combination thereof). For example, a line may include a separable plastic conduit. In a specific embodiment to reduce package size, the fuel cell and the fuel processor may each include a molded channel dedicated to the delivering hydrogen from the processor to the cell. The channeling may be included in a structure for each. When the fuel cell attaches directly to the fuel processor, the hydrogen transport line then includes a) channeling in the fuel processor to deliver hydrogen from a reformer to the connection, and b) channeling in the fuel cell to deliver the hydrogen from the connection to a hydrogen intake manifold. An interconnect may also facilitate connection between the fuel cell and the fuel processor. The interconnect includes an integrated hydrogen conduit dedicated to hydrogen transfer from the fuel processor to the fuel cell. Other plumbing techniques known to those of skill in the art may be used to transport fluids in a line.

Flow control is provided on each line 27 and 29. In this embodiment, separate pumps 21a and 21b are provided for lines 27 and 29, respectively, to pressurize each line separately and transfer methanol at independent rates, if desired. A model 030SP-S6112 pump as provided by Biochem, N.J. is suitable to transmit liquid methanol on either line in a specific embodiment. A diaphragm or piezoelectric pump is also suitable for use with system 10. A flow restriction may also be provided on each line 27 and 29 to facilitate sensor feedback and flow rate control. In conjunction with suitable control, such as digital control applied by a processor that implements instructions from stored software, each pump 21 responds to control signals from the processor and moves a desired amount of methanol 17 from storage device 16 to heater 30 and reformer 32 on each line 27 and 29.

Air source 41 delivers oxygen and air from the ambient room through line 31 to the cathode in fuel cell 20, where some oxygen is used in the cathode to generate electricity. Air source 41 may include a pump, fan, blower, or compressor, for example.

High operating temperatures in fuel cell 20 also heat the oxygen and air. In the embodiment shown, the heated oxygen and air is then transmitted from the fuel cell, via line 33, to a regenerator 36 (also referred to herein as a ‘dewar’) of fuel processor 15, where the air is additionally heated (by escaping heat from heater 30) before the air enters heater 30. This double pre-heating increases efficiency of fuel cell system 10 by a) reducing heat lost to reactants in heater 30 (such as fresh oxygen that would otherwise be near room temperature when combusted in the heater), and b) cooling the fuel cell during energy production. In a specific embodiment, a model BTC compressor as provided by Hargraves, N.C. is suitable to pressurize oxygen and air for fuel cell system 10.

When fuel cell cooling is needed, a fan 37 blows air from the ambient room over fuel cell 20. Fan 37 may be suitably sized to move air as desired by the heating requirements of fuel cell 20; and many vendors known to those of skill in the art provide fans and blowers suitable for use with package 10.

Fuel processor 15 is configured to process fuel 17 and output hydrogen. Fuel processor 15 comprises heater 30, reformer 32, boiler 34, and regenerator 36. Heater 30 (also referred to herein as a burner when it uses catalytic combustion to generate heat) includes an inlet that receives methanol 17 from line 27. In a specific embodiment, the burner includes a catalyst that helps generate heat from methanol, such as platinum or palladium coated onto a suitable support or alumina pellets for example.

In a specific embodiment, heater 30 includes its own boiler to preheat fuel for the heater. Boiler 34 includes a chamber having an inlet that receives methanol 17 from line 29. The boiler chamber is configured to receive heat from heater 30, via heat conduction through one or more walls between the boiler 34 and heater 30, and use the heat to boil the methanol passing through the boiler chamber. The structure of boiler 34 permits heat produced in heater 30 to heat methanol 17 in boiler 34 before reformer 32 receives the methanol 17. In a specific embodiment, the boiler chamber is sized to boil methanol before receipt by reformer 32. Boiler 34 includes an outlet that provides heated methanol 17 to reformer 32.

Reformer 32 includes an inlet that receives heated methanol 17 from boiler 34. A catalyst in reformer 32 reacts with the methanol 17 to produce hydrogen and carbon dioxide; this reaction is endothermic and draws heat from heater 30. A hydrogen outlet of reformer 32 outputs hydrogen to line 39. In one embodiment, fuel processor 15 also includes a preferential oxidizer that intercepts reformer 32 hydrogen exhaust and decreases the amount of carbon monoxide in the exhaust. The preferential oxidizer employs oxygen from an air inlet to the preferential oxidizer and a catalyst, such as ruthenium that is preferential to carbon monoxide over hydrogen.

Regenerator 36 pre-heats incoming air before the air enters heater 30. In one sense, regenerator 36 uses outward traveling waste heat in fuel processor 15 to increase thermal management and thermal efficiency of the fuel processor. Specifically, waste heat from heater 30 pre-heats incoming air provided to heater 30 to reduce heat transfer to the air within the heater. As a result, more heat transfers from the heater to reformer 32. The regenerator also functions as insulation. More specifically, by reducing the overall amount of heat loss from fuel processor 15, regenerator 36 also reduces heat loss from package 11. This enables a cooler fuel cell system 10 package.

In one embodiment, fuel processor 15 includes a monolithic structure having common walls between the heater 30 and other chambers in the fuel processor. Fuel processors suitable for use herein are further described in commonly owned patent application Ser. No. 10/877,044.

Line 39 transports hydrogen (or ‘reformate’) from fuel processor 15 to fuel cell 20. In a specific embodiment, gaseous delivery lines 33, 35 and 39 include channels in a metal interconnect that couples to both fuel processor 15 and fuel cell 20. A hydrogen flow sensor (not shown) may also be added on line 39 to detect and communicate the amount of hydrogen being delivered to fuel cell 20. In conjunction with the hydrogen flow sensor and suitable control, such as digital control applied by a processor that implements instructions from stored software, system 10 regulates hydrogen gas provision to fuel cell 20.

Fuel cell 20 includes a hydrogen inlet port that receives hydrogen from line 39 and includes a hydrogen intake manifold that delivers the gas to one or more bi-polar plates and their hydrogen distribution channels. An oxygen inlet port of fuel cell 20 receives oxygen from line 31; an oxygen intake manifold receives the oxygen from the port and delivers the oxygen to one or more bi-polar plates and their oxygen distribution channels. A cathode exhaust manifold collects gases from the oxygen distribution channels and delivers them to a cathode exhaust port and line 33, or to the ambient room. An anode exhaust manifold 38 collects gases from the hydrogen distribution channels, and in one embodiment, delivers the gases to the ambient room.

In a specific embodiment, and as shown, the anode exhaust is transferred back to fuel processor 15. In this case, system 10 comprises plumbing 38 that transports unused hydrogen from the anode exhaust to heater 30. For system 10, heater 30 includes two inlets: an inlet configured to receive fuel 17 and an inlet configured to receive hydrogen from line 38. Heater 30 then includes a thermal catalyst that reacts with the unused hydrogen to produce heat. Since hydrogen consumption within a PEM fuel cell 20 is often incomplete and the anode exhaust often includes unused hydrogen, re-routing the anode exhaust to heater 30 allows a fuel cell system to capitalize on unused hydrogen and increase hydrogen usage and energy efficiency. The fuel cell system thus provides flexibility to use different fuels in a catalytic heater 30. For example, if fuel cell 20 can reliably and efficiently consume over 90% of the hydrogen in the anode stream, then there may not be sufficient hydrogen to maintain reformer and boiler operating temperatures in fuel processor 15. Under this circumstance, methanol supply is increased to produce additional heat to maintain the reformer and boiler temperatures. In one embodiment, gaseous delivery in line 38 back to fuel processor 15 relies on pressure at the exhaust of the anode gas distribution channels, e.g., in the anode exhaust manifold. In another embodiment, an anode recycling pump or fan is added to line 38 to pressurize the line and return unused hydrogen back to fuel processor 15. The unused hydrogen is then combusted for heat generation.

In one embodiment, fuel cell 20 includes one or more heat transfer appendages 46 that permit conductive heat transfer with internal portions of a fuel cell stack. This may be done for heating and/or cooling fuel cell 20. In a specific heating embodiment, exhaust 35 of heater 30 is transported to the one or more heat transfer appendages 46 during system start-up to expedite reaching initial elevated operating temperatures in fuel cell 20. The heat may come from hot exhaust gases or unburned fuel in the exhaust, which then interacts with a catalyst disposed on or in proximity with a heat transfer appendage 46. In a specific cooling embodiment, fan 37 blows cooling air over the one or more heat transfer appendages 46, which provides dedicated and controllable cooling of the stack during electrical energy production. Fuel cells suitable for use herein are further described in commonly owned patent application Ser. No. 10/877,770, entitled “Micro Fuel Cell Thermal Management”, filed Jun. 25, 2004, which is incorporated by reference in its entirety for all purposes.

Heat exchanger 42 transfers heat from fuel cell system 10 to the inlet fuel 17 before the methanol reaches fuel processor 15. This increases thermal efficiency for system 10 by preheating the incoming fuel (to reduce heating of the fuel in heater 30) and reuses heat that would otherwise be expended from the system. While system 10 shows heat exchanger 42 heating methanol in line 29 that carries fuel 17 to the boiler 34 and reformer 32, it is understood that heat exchanger 42 may be used to heat methanol in line 27 that carries fuel 17 to burner 30.

In one embodiment, system 10 increases thermal and overall efficiency of a portable fuel cell system by using waste heat in the system to heat incoming reactants such as an incoming fuel or air. To this end, the embodiment in FIG. 1B includes heat exchanger, or recuperator, 42.

Heat exchanger 42 transfers heat from fuel cell system 10 to the inlet fuel 17 before the methanol reaches fuel processor 15. This increases thermal efficiency for system 10 by preheating the incoming fuel (to reduce heating of the fuel in heater 30) and reuses heat that would otherwise be expended from the system. While system 10 shows heat exchanger 42 heating methanol in line 29 that carries fuel 17 to the boiler 34 and reformer 32, it is understood that heat exchanger 42 may be used to heat methanol in line 27 that carries fuel 17 to burner 30.

In addition to the components shown in shown in FIG. 1B, system 10 may also include other elements such as electronic controls, additional pumps and valves, added system sensors, manifolds, heat exchangers and electrical interconnects useful for carrying out functionality of a fuel cell system 10 that are known to one of skill in the art and omitted for sake of brevity. FIG. 1B shows one specific plumbing arrangement for a fuel cell system; other plumbing arrangements are suitable for use herein. For example, the heat transfer appendages 46, a heat exchanger and dewar 36 need not be included. Other alterations to system 10 are permissible, as one of skill in the art will appreciate.

System 10 generates direct current (DC) voltage, and is suitable for use in a wide variety of portable applications. For example, electrical energy generated by fuel cell 20 may power a notebook computer 11 or a portable electrical generator 11 carried by military personnel.

In one embodiment, system 10 provides portable, or ‘small’, fuel cell systems that are configured to output less than 200 watts of power (net or total). Fuel cell systems of this size are commonly referred to as ‘micro fuel cell systems’ and are well suited for use with portable electronics devices. In one embodiment, the fuel cell is configured to generate from about 1 milliwatt to about 200 Watts. In another embodiment, the fuel cell generates from about 5 Watts to about 60 Watts. Fuel cell system 10 may be a stand-alone system, which is a single package 11 that produces power as long as it has access to a) oxygen and b) hydrogen or a fuel such as a hydrocarbon fuel. One specific portable fuel cell package produces about 25 Watts or about 45 Watts, depending on the number of cells in a stack for fuel cell 20.

While the embodiment discussed herein mainly been discussed so far with respect to a reformed methanol fuel cell (RMFC), the present invention may also apply to other types of fuel cells, such as a solid oxide fuel cell (SOFC), a phosphoric acid fuel cell (PAFC), a direct methanol fuel cell (DMFC), or a direct ethanol fuel cell (DEFC). In this case, fuel cell 20 includes components specific to these architectures, as one of skill in the art will appreciate. A DMFC or DEFC receives and processes a fuel. More specifically, a DMFC or DEFC receives liquid methanol or ethanol, respectively, channels the fuel into the fuel cell stack 60 and processes the liquid fuel to separate hydrogen for electrical energy generation. For a DMFC, shared flow fields 208 in the flow field plates 202 distribute liquid methanol instead of hydrogen. Hydrogen catalyst 126 described above would then comprise a suitable anode catalyst for separating hydrogen from methanol. Oxygen catalyst 128 would comprise a suitable cathode catalyst for processing oxygen or another suitable oxidant used in the DMFC, such as peroxide. In general, hydrogen catalyst 126 is also commonly referred to as an anode catalyst in other fuel cell architectures and may comprise any suitable catalyst that removes hydrogen for electrical energy generation in a fuel cell, such as directly from the fuel as in a DMFC. In general, oxygen catalyst 128 may include any catalyst that processes an oxidant in used in fuel cell 20. The oxidant may include any liquid or gas that oxidizes the fuel and is not limited to oxygen gas as described above. An SOFC, PAFC, or molten carbonate fuel cell (MCFC) may also benefit from inventions described herein, for example. In this case, fuel cell 20 comprises an anode catalyst 126, cathode catalyst 128, anode fuel and oxidant according to a specific SOFC, PAFC, or MCFC design.

Exemplary Fuel Cell

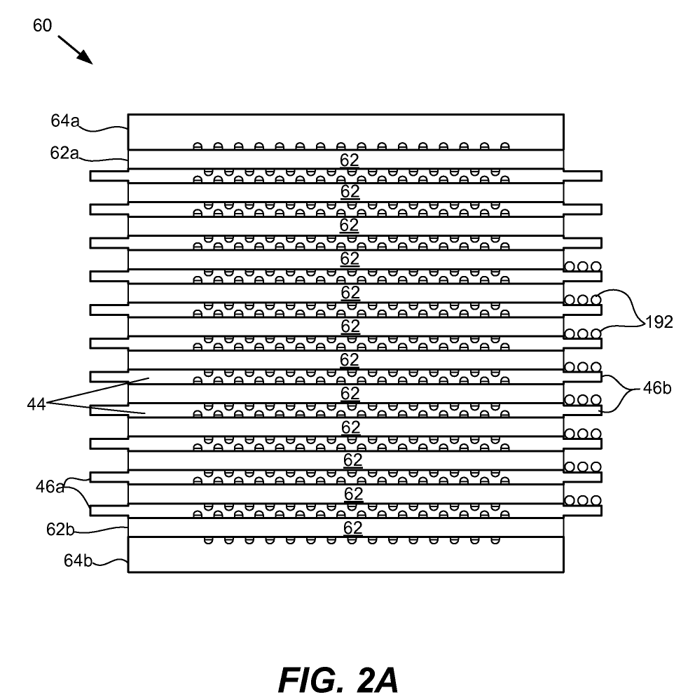

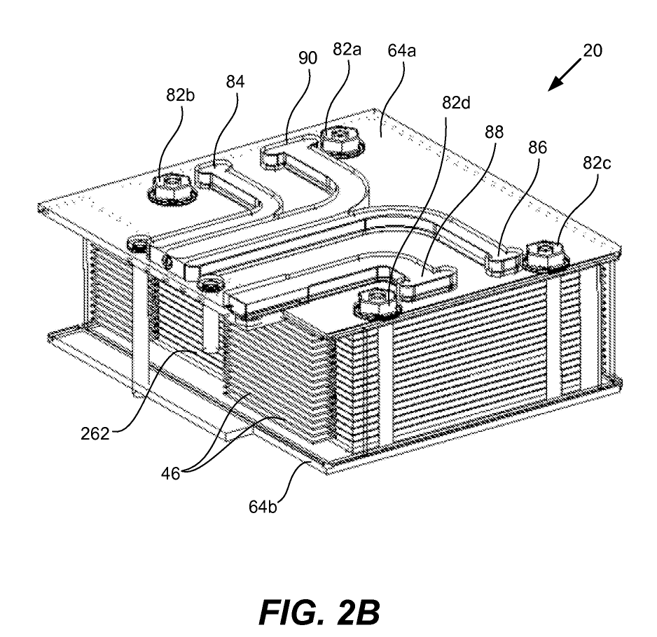

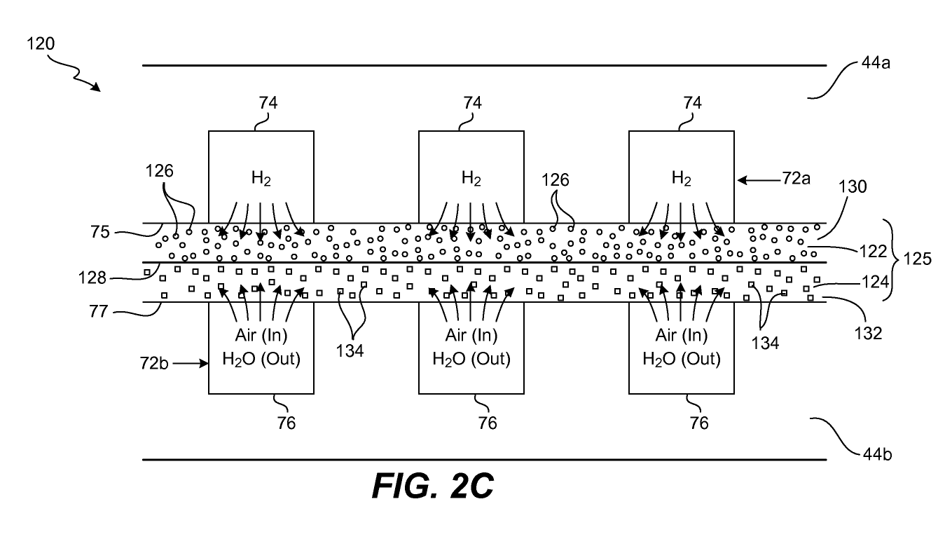

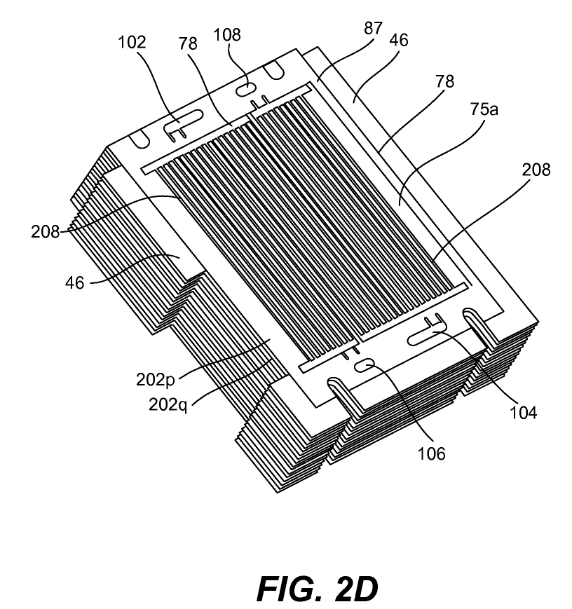

FIGS. 2A-2D illustrate an example fuel cell. FIG. 2A illustrates a cross sectional view of a fuel cell stack 60 for use in fuel cell 20. FIG. 2B illustrates an outer top perspective view of a fuel cell stack 60 and fuel cell 20.

Referring initially to FIG. 2A, fuel cell stack 60 includes a set of bi-polar plates 44 and a set of MEA layers 62. Two MEA layers 62 neighbor each bi-polar plate 44. With the exception of topmost and bottommost membrane electrode assembly layers 62a and 62b, each MEA 62 is disposed between two adjacent bi-polar plates 44. For MEAs 62a and 62b, top and bottom end plates 64a and 64b include a channel field 72 on the face neighboring an MEA 62.

The bi-polar plates 44 in stack 60 also each include one or more heat transfer appendages 46. As shown, each bi-polar plate 44 includes a heat transfer appendage 46a on one side of the plate and a heat transfer appendage 46b on the opposite side. Heat transfer appendages 46 are discussed in further detail below.

As shown in FIG. 2A, stack 60 includes twelve membrane electrode assembly layers 62, eleven bi-polar plates 44 and two end plates 64 (FIG. 2B shows 18 plates 44 in the stack). The number of bi-polar plates 44 and MEA layers 62 in each set may vary with design of fuel cell stack 60. Stacking parallel layers in fuel cell stack 60 permits efficient use of space and increased power density for fuel cell 20 and a fuel cell package 10 including fuel cell 20. In one embodiment, each membrane electrode assembly 62 produces 0.7 V and the number of MEA layers 62 is selected to achieve a desired voltage. Alternatively, the number of MEA layers 62 and bi-polar plates 44 may be determined by the allowable thickness of package 10. A fuel cell stack 60 having from one MEA 62 to several hundred MEAs 62 is suitable for many applications. A stack 60 having from about three MEAs 62 to about twenty MEAs 62 is also suitable for numerous applications. Fuel cell 20 size and layout may also be tailored and configured to output a given power.

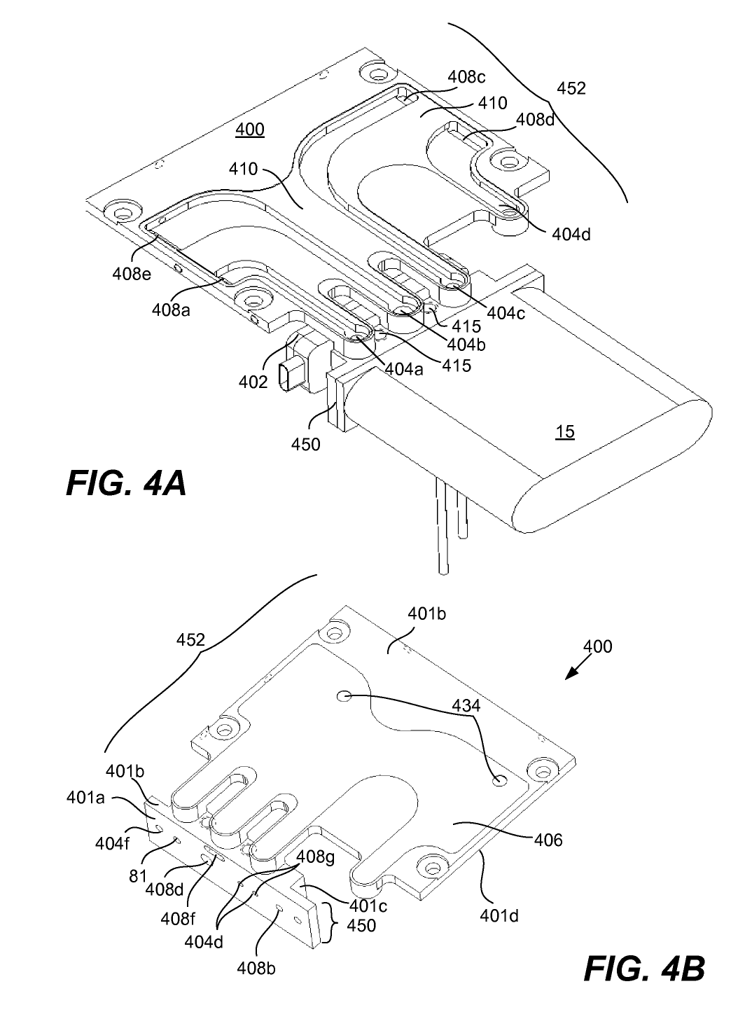

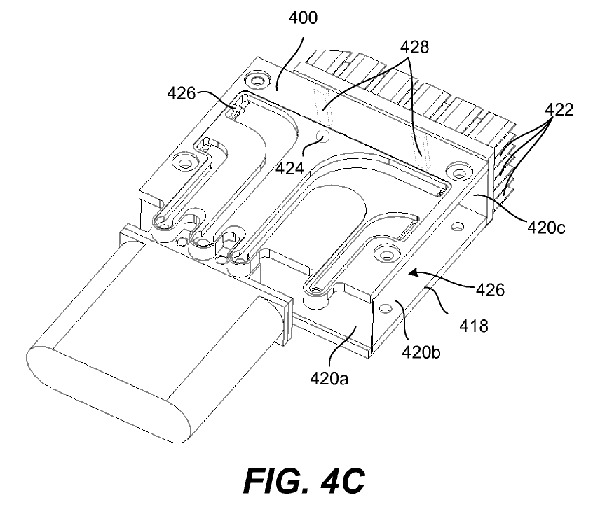

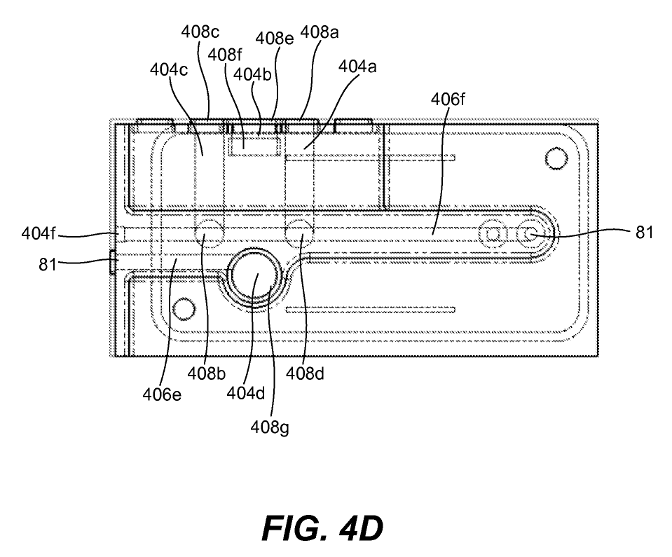

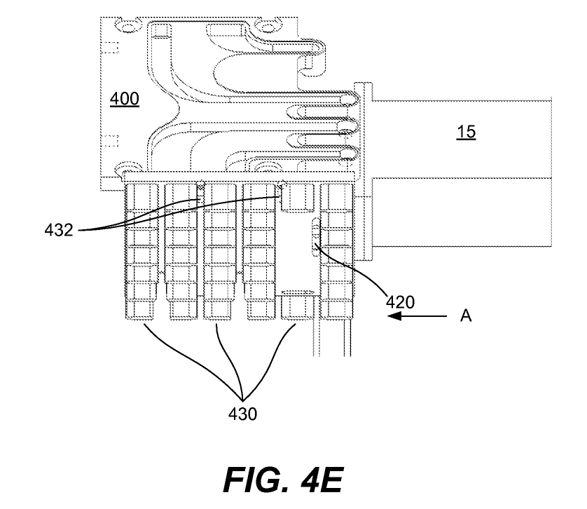

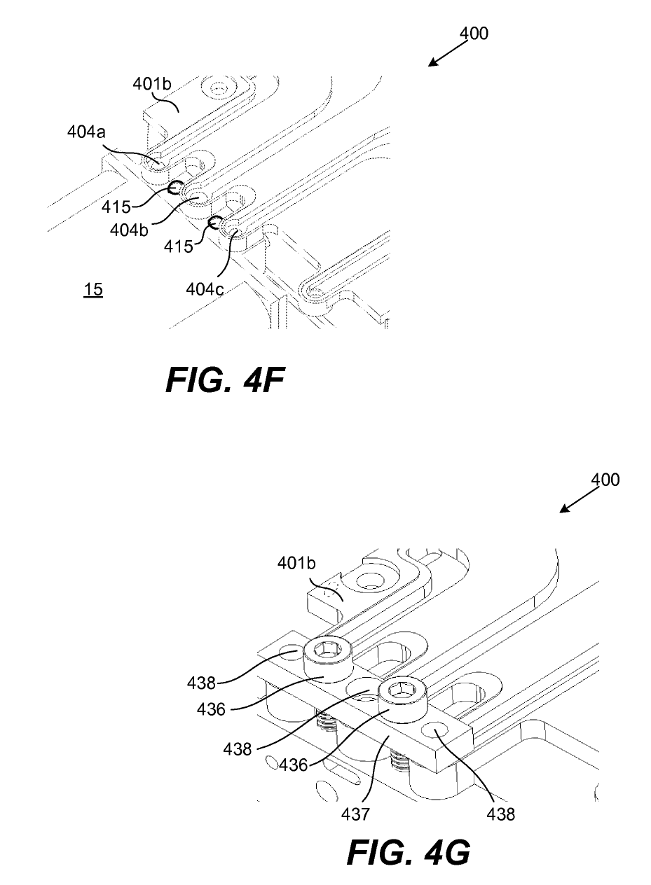

Referring to FIG. 2B, top and bottom end plates 64a and 64b provide mechanical protection for stack 60. As illustrated with reference to FIGS. 4A-4C, in one embodiment, top plate 64a may be part of an interconnect 400. End plates 64 also hold the bi-polar plates 44 and MEA layers 62 together, and apply pressure across the planar area of each bi-polar plate 44 and each MEA 62. End plates 64 may include steel or another suitably stiff material. Bolts 82a-d connect and secure top and bottom end plates 64a and 64b together.

Fuel cell 20 includes two anode manifolds (84 and 86). Each manifold delivers a product or reactant gas to or from the fuel cell stack 60. More specifically, each manifold delivers a gas between a vertical manifold created by stacking bi-polar plates 44 (FIG. 2D) and plumbing external to fuel cell 20. Inlet hydrogen manifold 84 is disposed on top end plate 64a, couples with an inlet conduit to receive hydrogen gas (such as 204a in FIG. 4A), and opens to an inlet hydrogen manifold 102 (FIG. 2D) that is configured to deliver inlet hydrogen gas to a channel field 72 on each bi-polar plate 44 in stack 60. Outlet manifold 86 receives outlet gases from an anode exhaust manifold 104 (FIG. 2D) that is configured to collect waste products from the anode channel fields 72 of each bi-polar plate 44. Outlet manifold 86 may provide the exhaust gases to the ambient space about the fuel cell. In another embodiment, manifold 86 provides the anode exhaust to line 38, which transports the unused hydrogen back to the fuel processor during start-up.

Fuel cell 20 includes two cathode manifolds: an inlet cathode manifold or inlet oxygen manifold 88, and an outlet cathode manifold or outlet water/vapor manifold 90. Inlet oxygen manifold 88 is disposed on top end plate 64a, couples with an inlet conduit (conduit 31, which draws air from the ambient room) to receive ambient air, and opens to an oxygen manifold 106 (FIG. 2D) that is configured to deliver inlet oxygen and ambient air to a channel field 72 on each bi-polar plate 44 in stack 60. Outlet water/vapor manifold 90 receives outlet gases from a cathode exhaust manifold 108 (FIG. 2D) that is configured to collect water (typically as a vapor) from the cathode channel fields 72 on each bi-polar plate 44.

As shown in FIG. 2B, manifolds 84, 86, 88 and 90 include molded channels that each travel along a top surface of end plate 64a from their interface from outside the fuel cell to a manifold in the stack. Each manifold or channel acts as a gaseous communication line for fuel cell 20 and may comprise a molded channel in plate 64 or a housing of fuel cell 20. Other arrangements to communicate gases to and from stack 60 are contemplated, such as those that do not share common manifolding in a single plate or structure.

FIG. 2C illustrates an ion conductive membrane fuel cell (PEMFC) architecture 120 for use in fuel cell 20 in accordance with one embodiment of the present invention. As shown, PEMFC architecture 120 comprises two bi-polar plates 44 and a membrane electrode assembly layer (or MEA) 62 sandwiched between the two bi-polar plates 44. The MEA 62 electrochemically converts hydrogen and oxygen to water and generates electrical energy and heat in the process. Membrane electrode assembly 62 includes an anode gas diffusion layer 122, a cathode gas diffusion layer 124, a hydrogen catalyst 126, ion conductive membrane 128, anode electrode 130, cathode electrode 132, and oxygen catalyst 134.

Pressurized hydrogen gas (H₂) enters fuel cell 20 via hydrogen port 84, proceeds through inlet hydrogen manifold 102 and through hydrogen channels 74 of a hydrogen channel field 72a disposed on the anode face 75 of bi-polar plate 44a. The hydrogen channels 74 open to anode gas diffusion layer 122, which is disposed between the anode face 75 of bi-polar plate 44a and ion conductive membrane 128. The pressure forces hydrogen gas into the hydrogen-permeable anode gas diffusion layer 122 and across the hydrogen catalyst 126, which is disposed in the anode gas diffusion layer 122. When an H₂ molecule contacts hydrogen catalyst 126, it splits into two H+ ions (protons) and two electrons (e−). The protons move through the ion conductive membrane 128 to combine with oxygen in cathode gas diffusion layer 124. The electrons conduct through the anode electrode 130, where they build potential for use in an external circuit (e.g., a power supply of a laptop computer) After external use, the electrons flow to the cathode electrode 132 of PEMFC architecture 120.

Hydrogen catalyst 126 breaks hydrogen into protons and electrons. Suitable catalysts 126 include platinum, ruthenium, and platinum black or platinum carbon, and/or platinum on carbon nanotubes, for example. Anode gas diffusion layer 122 comprises any material that allows the diffusion of hydrogen therethrough and is capable of holding the hydrogen catalyst 126 to allow interaction between the catalyst and hydrogen molecules. One such suitable layer comprises a woven or non-woven carbon paper. Other suitable gas diffusion layer 122 materials may comprise a silicon carbide matrix and a mixture of a woven or non-woven carbon paper and Teflon.

On the cathode side of PEMFC architecture 120, pressurized air carrying oxygen gas (O₂) enters fuel cell 20 via oxygen port 88, proceeds through inlet oxygen manifold 106, and through oxygen channels 76 of an oxygen channel field 72b disposed on the cathode face 77 of bi-polar plate 44b. The oxygen channels 76 open to cathode gas diffusion layer 124, which is disposed between the cathode face 77 of bi-polar plate 44b and ion conductive membrane 128. The pressure forces oxygen into cathode gas diffusion layer 124 and across the oxygen catalyst 134 disposed in the cathode gas diffusion layer 124. When an O₂ molecule contacts oxygen catalyst 134, it splits into two oxygen atoms. Two H+ ions that have traveled through the ion selective ion conductive membrane 128 and an oxygen atom combine with two electrons returning from the external circuit to form a water molecule (H₂O). Cathode channels 76 exhaust the water, which usually forms as a vapor. This reaction in a single MEA layer 62 produces about 0.7 volts.

Cathode gas diffusion layer 124 comprises a material that permits diffusion of oxygen and hydrogen protons therethrough and is capable of holding the oxygen catalyst 134 to allow interaction between the catalyst 134 with oxygen and hydrogen. Suitable gas diffusion layers 124 may comprise carbon paper or cloth, for example. Other suitable gas diffusion layer 124 materials may comprise a silicon carbide matrix and a mixture of a woven or non-woven carbon paper and Teflon. Oxygen catalyst 134 facilitates the reaction of oxygen and hydrogen to form water. One common catalyst 134 comprises platinum. Many designs employ a rough and porous catalyst 134 to increase surface area of catalyst 134 exposed to the hydrogen or oxygen. For example, the platinum may reside as a powder very thinly coated onto a carbon paper or cloth cathode gas diffusion layer 124.

Ion conductive membrane 128 electrically isolates the anode from the cathode by blocking electrons from passing through membrane 128. Thus, membrane 128 prevents the passage of electrons between gas diffusion layer 122 and gas diffusion layer 124. Ion conductive membrane 128 also selectively conducts positively charged ions, e.g., hydrogen protons from gas diffusion layer 122 to gas diffusion layer 124. For fuel cell 20, protons move through membrane 128 and electrons are conducted away to an electrical load or battery. In one embodiment, ion conductive membrane 128 comprises an electrolyte. One electrolyte suitable for use with fuel cell 20 is PolyBenzImidazole (PBI) doped with phosphoric acid as included in Celtec P1000 membrane electrode assemblies (MEA) from BASF Fuel Cells of Frankfurt, Germany. Fuel cells 20 including this electrolyte are generally more carbon monoxide tolerant and may not require humidification. Ion conductive membrane 128 may also employ a phosphoric acid matrix that includes a porous separator impregnated with phosphoric acid. Alternative ion conductive membranes 128 suitable for use with fuel cell 20 are widely available from companies such as United technologies, Superprotonic, DuPont, 3M, and other manufacturers known to those of skill in the art. For example, WL Gore Associates of Elkton, Md. produces the primea Series 58, which is a low temperature MEA suitable for use with the present invention.

In one embodiment, fuel cell 20 requires no external humidifier or heat exchanger and the stack 60 only needs hydrogen and air to produce electrical power. Alternatively, fuel cell 20 may employ humidification of the cathode to fuel cell 20 improve performance. For some fuel cell stack 60 designs, humidifying the cathode increases the power and operating life of fuel cell 20.

FIG. 2D illustrates a top perspective view of a stack of bi-polar plates (with the top two plates labeled 44p and 44q) in accordance with one embodiment of the present invention. Bi-polar plate 44 is a single plate 44 with first channel fields 72 disposed on opposite faces 75 of the plate 44.

Functionally, bi-polar plate 44 a) delivers and distributes reactant gases to the gas diffusion layers 122 and 124 and their respective catalysts, b) maintains separation of the reactant gasses from one another between MEA layers 62 in stack 60, c) exhausts electrochemical reaction byproducts from MEA layers 62, d) facilitates heat transfer to and/or from MEA layers 62 and fuel cell stack 60, and e) includes gas intake and gas exhaust manifolds for gas delivery to other bi-polar plates 44 in the fuel stack 60.

Structurally, bi-polar plate 44 has a relatively flat profile and includes opposing top and bottom faces 75a and 75b (only top face 75a is shown) and a number of sides 78. Faces 75 are substantially planar with the exception of channels 76 formed as troughs into substrate 89. Sides 78 comprise portions of bi-polar plate 44 proximate to edges of bi-polar plate 44 between the two faces 75. As shown, bi-polar plate 44 is roughly quadrilateral with features for the intake manifolds, exhaust manifolds and heat transfer appendage 46 that provide outer deviation from a quadrilateral shape.

The manifold on each plate 44 is configured to deliver a gas to a channel field on a face of the plate 44 or receive a gas from the channel field 72. The manifolds for bi-polar plate 44 include apertures or holes in substrate 89 that, when combined with manifolds of other plates 44 in a stack 60, form an inter-plate 44 gaseous communication manifold (such as 102, 104, 106 and 108). Thus, when plates 44 are stacked and their manifolds substantially align, the manifolds permit gaseous delivery to and from each plate 44.

Bi-polar plate 44 includes a channel field 72 or “flow field” on each face of plate 44. Each channel field 72 includes one or more channels 76 formed into the substrate 89 of plate 44 such that the channel rests below the surface of plate 44. Each channel field 72 distributes one or more reactant gasses to an active area for the fuel cell stack 60. Bi-polar plate 44 includes a first channel field 72a on the anode face 75a of bi-polar plate 44 that distributes hydrogen to an anode (FIG. 2C), while a second channel field on opposite cathode face 75b distributes oxygen to a cathode. Specifically, channel field 72a includes multiple channels 76 that permit oxygen and air flow to anode gas diffusion layer 122, while channel field 72b includes multiple channels 76 that permit oxygen and air flow to cathode gas diffusion layer 124. For fuel cell stack 60, each channel field 72 is configured to receive a reactant gas from an intake manifold 102 or 106 and configured to distribute the reactant gas to a gas diffusion layer 122 or 124. Each channel field 72 also collects reaction byproducts for exhaust from fuel cell 20. When bi-polar plates 44 are stacked together in fuel cell 60, adjacent plates 44 sandwich an MEA layer 62 such that the anode face 75a from one bi-polar plate 44 neighbors a cathode face 75b of an adjacent bi-polar plate 44 on an opposite side of the MEA layer 62.

Bi-polar plate 44 may include one or more heat transfer appendages 46. Each heat transfer appendage 46 permits external thermal management of internal portions of fuel cell stack 60. More specifically, appendage 46 may be used to heat or cool internal portions of fuel cell stack 60 such as internal portions of each attached bi-polar plate 44 and any neighboring MEA layers 62, for example. Heat transfer appendage 46 is laterally arranged outside channel field 72. In one embodiment, appendage 46 is disposed on an external portion of bi-polar plate 44. External portions of bi-polar plate 44 include any portions of plate 44 proximate to a side or edge of the substrate included in plate 44. External portions of bi-polar plate 44 typically do not include a channel field 72. For the embodiment shown, heat transfer appendage 46 substantially spans a side of plate 44 that does not include intake and output manifolds 102-108. For the embodiment shown in FIG. 2A, plate 44 includes two heat transfer appendages 46 that substantially span both sides of plate 44 that do not include a gas manifold.

Peripherally disposing heat transfer appendage 46 allows heat transfer between inner portions of plate 44 and the externally disposed appendage 46 via the plate substrate 89. Conductive thermal communication refers to heat transfer between bodies that are in contact or that are integrally formed. Thus, lateral conduction of heat between external portions of plate 44 (where the heat transfer appendage 46 attaches) and central portions of bi-polar plate 44 occurs via conductive thermal communication through substrate 89. In one embodiment, heat transfer appendage 46 is integral with substrate material 89 in plate 44. Integral in this sense refers to material continuity between appendage 46 and plate 44. An integrally formed appendage 46 may be formed with plate 44 in a single molding, stamping, machining or MEMs process of a single metal sheet, for example. Integrally forming appendage 46 and plate 44 permits conductive thermal communication and heat transfer between inner portions of plate 44 and the heat transfer appendage 46 via substrate 89. In another embodiment, appendage 46 comprises a material other than that used in substrate 89 that is attached onto plate 44 and conductive thermal communication and heat transfer occurs at the junction of attachment between the two attached materials.

Heat may travel to or form the heat transfer appendage 46. In other words, appendage 46 may be employed as a heat sink or source. Thus, heat transfer appendage 46 may be used as a heat sink to cool internal portions of bi-polar plate 44 or an MEA 62. Fuel cell 20 employs a cooling medium to remove heat from appendage 46. Alternatively, heat transfer appendage 46 may be employed as a heat source to provide heat to internal portions of bi-polar plate 44 or an MEA 62. In this case, a catalyst may be disposed on appendage 46 to generate heat in response to the presence of a heating medium.

For cooling, heat transfer appendage 46 permits integral conductive heat transfer from inner portions of plate 44 to the externally disposed appendage 46. During hydrogen consumption and electrical energy production, the electrochemical reaction generates heat in each MEA 62. Since internal portions of bi-polar plate 44 are in contact with the MEA 62, a heat transfer appendage 46 on a bi-polar plate 44 thus cools an MEA 62 adjacent to the plate via a) conductive heat transfer from MEA 62 to bi-polar plate 44 and b) lateral thermal communication and conductive heat transfer from central portions of the bi-polar plate 44 in contact with the MEA 62 to the external portions of plate 44 that include appendage 46. In this case, heat transfer appendage 46 sinks heat from substrate 89 between a first channel field 72 on one face 75 of plate 44 and a second channel field 72 on the opposite face of plate 44 to heat transfer appendage 46 in a direction parallel to a face 75 of plate 44. When a fuel cell stack 60 includes multiple MEA layers 62, lateral thermal communication through each bi-polar plate 44 in this manner provides interlayer cooling of multiple MEA layers 62 in stack 60—including those layers in central portions of stack 60.

Fuel cell 20 may employ a cooling medium that passes over heat transfer appendage 46. The cooling medium receives heat from appendage 46 and removes the heat from fuel cell 20. Heat generated internal to stack 60 thus conducts through bi-polar plate 44, to appendage 46, and heats the cooling medium via convective heat transfer between the appendage 46 and cooling medium. Air is suitable for use as the cooling medium.

Heat transfer appendage 46 may be configured with a thickness that is less than the thickness between opposite faces 75 of plate 44. The reduced thickness of appendages 46 on adjacent bi-polar plates 44 in the fuel cell stack 60 forms a channel between adjacent appendages. Multiple adjacent bi-polar plates 44 and appendages 46 in stack form numerous channels. Each channel permits a cooling medium or heating medium to pass therethrough and across heat transfer appendages 46. In one embodiment, fuel cell stack 60 includes a mechanical housing that encloses and protects stack 60. Walls of the housing also provide additional ducting for the cooling or heating medium by forming ducts between adjacent appendages 46 and the walls.

The cooling medium may be a gas or liquid. Heat transfer advantages gained by high conductance bi-polar plates 44 allow air to be used as a cooling medium to cool heat transfer appendages 46 and stack 60. For example, a DC-fan 37 may be attached to an external surface of the mechanical housing. The fan 37 moves air through a hole in the mechanical housing, through the channels between appendages to cool heat transfer appendages 46 and fuel cell stack 60, and out an exhaust hole or port in the mechanical housing. Fuel cell system 10 may then include active thermal controls based on temperature sensed feedback. Increasing or decreasing coolant fan speed regulates the amount of heat removal from stack 60 and the operating temperature for stack 60. In one embodiment of an air-cooled stack 60, the coolant fan speed increases or decreases as a function of the actual cathode exit temperature, relative to a desired temperature set-point.

For heating, heat transfer appendage 46 allows integral heat transfer from the externally disposed appendage 46 to inner portions of plate 44 and any components and portions of fuel cell 20 in thermal communication with inner portions of plate 44. A heating medium passed over the heat transfer appendage 46 provides heat to the appendage. Heat convected onto the appendage 46 then conducts through the substrate 89 and into internal portions of plate 44 and stack 60, such as portions of MEA 62 and its constituent components.

In one embodiment, the heating medium comprises a heated gas having a temperature greater than that of appendage 46. Exhaust gases from heater 30 or reformer 32 of fuel processor 15 may each include elevated temperatures that are suitable for heating one or more appendages 46.

In another embodiment, fuel cell comprises a catalyst 192 (FIG. 2A) disposed in contact with, or in proximity to, one or more heat transfer appendages 46. The catalyst 192 generates heat when the heating medium passes over it. The heating medium in this case may comprise any gas or fluid that reacts with catalyst 192 to generate heat. Typically, catalyst 192 and the heating medium employ an exothermic chemical reaction to generate the heat. Heat transfer appendage 46 and plate 44 then transfer heat into the fuel cell stack 60, e.g. to heat internal MEA layers 62. For example, catalyst 192 may comprise platinum and the heating medium includes the hydrocarbon fuel source 17. The fuel source 17 may be heated to a gaseous state before it enters fuel cell 20. This allows gaseous transportation of the heating medium and gaseous interaction between the fuel source 17 and catalyst 192 to generate heat. Similar to the cooling medium described above, a fan disposed on one of the walls then moves the gaseous heating medium within fuel cell 20.

In a specific embodiment, the hydrocarbon fuel source 17 used to react with catalyst 192 comes from a reformer exhaust (see FIG. 1C) or heater exhaust in fuel processor 15. This advantageously pre-heats the fuel source 17 before receipt within fuel cell 20 and also efficiently uses or burns any fuel remaining in the reformer or heater exhaust after processing by fuel processor 15. Alternatively, fuel cell 20 may include a separate hydrocarbon fuel source 17 feed that directly supplies hydrocarbon fuel source 17 to fuel cell 20 for heating and reaction with catalyst 192. In this case, catalyst 192 may comprise platinum. Other suitable catalysts 192 include palladium, a platinum/palladium mix, iron, ruthenium, and combinations thereof. Each of these will react with a hydrocarbon fuel source 17 to generate heat. Other suitable heating mediums include hydrogen or any heated gases emitted from fuel processor 15, for example.

When hydrogen is used as the heating medium, catalyst 192 comprises a material that generates heat in the presence of hydrogen, such as palladium or platinum. As will be described in further detail below, the hydrogen may include hydrogen supplied from the reformer 32 in fuel processor 15 as exhaust.

As shown in FIG. 2A, catalyst 192 is arranged on, and in contact with, each heat transfer appendage 46. In this case, the heating medium passes over each appendage 46 and reacts with catalyst 192. This generates heat, which is absorbed via conductive thermal communication by the cooler appendage 46. Wash coating may be employed to dispose catalyst 192 on each appendage 46. A ceramic support may also be used to bond catalyst 192 on an appendage 46.

For catalyst-based heating, heat then a) transfers from catalyst 192 to appendage 46, b) moves laterally though bi-polar plate 44 via conductive heat transfer from lateral portions of the plate that include heat transfer appendage 46 to central portions of bi-polar plate 44 in contact with the MEA layers 62, and c) conducts from bi-polar plate 44 to MEA layer 62. When a fuel cell stack 60 includes multiple MEA layers 62, lateral heating through each bi-polar plate 44 provides interlayer heating of multiple MEA layers 62 in stack 60, which expedites fuel cell 20 warm up.

Bi-polar plates 44 of FIG. 2A include heat transfer appendages 46 on each side. In this case, one set of heat transfer appendages 46a is used for cooling while the other set of heat transfer appendages 46b is used for heating. Bi-polar plates 44 illustrated in FIG. 2D show plates 44 with four heat transfer appendages 46 disposed on three sides of stack 60. Appendage 46 arrangements can be otherwise varied to affect and improve heat dissipation and thermal management of fuel cell stack 60 according to other specific designs. For example, appendages 46 need not span a side of plate 44 as shown and may be tailored based on how the heating fluid is channeled through the housing.

Although the present invention provides a bi-polar plate 44 having channel fields 72 that distribute hydrogen and oxygen on opposing sides of a single plate 44, many embodiments described herein are suitable for use with conventional bi-polar plate assemblies that employ two separate plates for distribution of hydrogen and oxygen.

Exemplary Fuel Processor

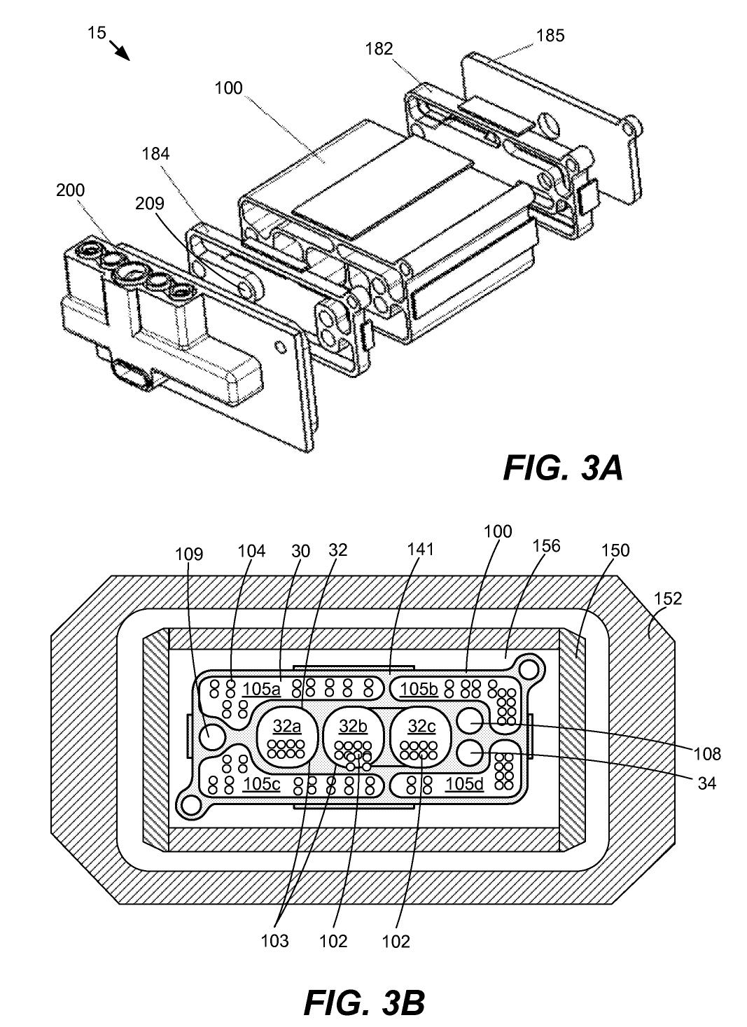

FIGS. 3A and 3B illustrate an example fuel processor. FIG. 3A illustrates a top perspective view of the fuel processor used in a fuel cell system. Fuel processor 15 may reform methanol to produce hydrogen. Fuel processor 15 comprises monolithic structure 100, end plates 182 and 184, end plate 185, reformer 32, heater 30, boiler 34, boiler 108, recuperator 150 and housing 152 (FIG. 3B). Although the present invention will now be described with respect to methanol consumption for hydrogen production, it is understood that fuel processors of the present invention may consume another fuel source, such as ethanol, gasoline, propane, and other fuel sources.

As the term is used herein, ‘monolithic’ refers to a single and integrated structure that includes at least portions of multiple components used in fuel processor 15. As shown in FIG. 3B, a cross-sectional front view of monolithic structure 100 taken through a mid-plane of fuel processor 15, monolithic structure 100 includes reformer 32, burner 30, boiler 34 and boiler 108. Monolithic structure 100 also includes associated plumbing inlets and outlets for reformer 32, burner 30 and boiler 34 disposed on end plates 182 and 184 and interconnect 200. Monolithic structure 100 comprises a common material 141 that constitutes the structure. The monolithic structure 100 and common material 141 simplify manufacture of fuel processor 15. For example, using a metal for common material 141 allows monolithic structure 100 to be formed by extrusion. In a specific embodiment, monolithic structure 100 is consistent in cross sectional dimensions between end plates 182 and 184 and solely comprises copper formed in a single extrusion.

An interconnect 200 may be disposed at least partially between the fuel cell and the fuel processor to form a structural and plumbing intermediary between the two. FIG. 3A illustrates one embodiment of an interconnect 200, which is also described in commonly owned co-pending patent application Ser. No. 11/120,643, entitled “Compact Fuel Cell Package”, filed May 2, 2005 which is incorporated by reference for all purposes, and will not be discussed herein for brevity. However, other embodiments of an interconnect may be used as discussed below with reference to FIGS. 4A-4F wherein the interconnect may be a single device that functions as a manifold for the fuel processor and the fuel cell stack.

Housing 152 provides mechanical protection for internal components of fuel processor 15 such as burner 30 and reformer 32. Housing 152 also provides separation from the environment external to processor 15 and includes inlet and outlet ports for gaseous and liquid communication in and out of fuel processor 15. Housing 152 includes a set of housing walls that at least partially contain a recuperator 150 and provides external mechanical protection for components in fuel processor 15. The walls may comprise a suitably stiff material such as a metal or a rigid polymer, for example. Recuperator 150 improves thermal heat management for fuel processor 15 by a) allowing incoming air to be pre-heated before entering burner 30, b) dissipating heat generated by burner 32 into the incoming air before the heat reaches the outside of housing 152.

Boiler 34 heats methanol before reformer 32 receives the methanol. Boiler 34 receives methanol via a fuel source inlet 81 on interconnect 200, which couples to a methanol supply line 27 (FIG. 1B). Since methanol reforming and hydrogen production via a catalyst 102 in reformer 32 often requires elevated methanol temperatures, fuel processor 15 pre-heats the methanol before receipt by reformer 32 via boiler 34. Boiler 34 is disposed in proximity to burner 30 to receive heat generated in burner 30. The heat transfers via conduction through monolithic structure from burner 30 to boiler 34 and via convection from boiler 34 walls to the methanol passing therethrough. In one embodiment, boiler 34 is configured to vaporize liquid methanol. Boiler 34 then passes the gaseous methanol to reformer 32 for gaseous interaction with catalyst 102.

Reformer 32 is configured to receive methanol from boiler 34. Walls 111 in monolithic structure 100 and end walls 113 on end plates 182 and 184 define dimensions for a reformer chamber 103. In one embodiment, end plate 182 and/or end plate 184 includes a channel that routes heated methanol exhausted from boiler 34 into reformer 32.

In one embodiment, a reformer includes a multi-pass arrangement. Reformer 32 includes three multi-pass portions that process methanol in series: chamber section 32a, chamber section 32b, and chamber section 32c. A reformer chamber 103 then includes the volume of all three sections 32a-c. Each section traverses the length of monolithic structure 100 and opens to each other in series such that sections 32a-c form one continuous path for gaseous flow. More specifically, heated and gaseous methanol from boiler 34 a) enters reformer chamber section 32a at an inlet end of monolithic structure 100 and flows to the other end over catalyst 102 in section 32a, b) then flows into chamber section 32b at the second end of monolithic structure 100 and flows to the inlet end over catalyst 102 in section 32b, and c) flows into chamber section 32c at one end of monolithic structure 100 and flows to the other end over catalyst 102 in the chamber section 32c.

Reformer 32 includes a catalyst 102 that facilitates the production of hydrogen. Catalytic combustion provides heat for the reforming process and lessens emissions. Better heat and mass transfer improves performance of the reforming process, both with regard to combustion and steam reforming. Catalyst 102 reacts with methanol and produces hydrogen gas and carbon dioxide. In one embodiment, catalyst 102 comprises pellets packed to form a porous catalyst bed or otherwise suitably filled into the volume of reformer chamber 103. Pellet diameters ranging from about 50 microns to about 1.5 millimeters are suitable for many applications. Pellet diameters ranging from about 500 microns to about 1 millimeter are suitable for use with reformer 32. Pellet sizes may be varied relative to the cross sectional size of reformer sections 32a-c, e.g., as the reformer sections increase in size so does catalyst 102 pellet diameters.

Pellet sizes and packing may also be varied to control the pressure drop that occurs through reformer chamber 103. In one embodiment, pressure drops from about 0.2 to about 2 psi gauge are suitable between the inlet and outlet of reformer chamber 103. However, the mass of gaseous material flowing through the reactor may affect heat transfer. For example, the pressure drop across a packed catalyst bed may be relatively high and the fans, blowers or compressors used in the process may limit mass flow through the catalyst bed. The combustion process may further be limited by the use of oxygen depleted “air” and require high volumetric flows through the catalyst bed to provide sufficient oxygen for complete combustion. The cooling effect of these high flows may be substantial as the heating and cooling of large volumes of inert gases may decrease the efficiency of the fuel cell system 10.

One suitable catalyst 102 may include copper-zinc alloy (CuZn) coated onto alumina pellets when methanol is used as a hydrocarbon fuel source 17. Other materials suitable for catalyst 102 include platinum (Pt), palladium (Pd), a platinum/palladium mix, nickel, and other precious metal catalysts for example. In another embodiment, catalyst 102 may also comprise catalyst materials listed herein coated onto a metal sponge or metal foam. However, some catalysts used for combustion may include a shell of active material, such Pt or Pd, on an alumina core. The bulk of the catalyst may consist of the alumina, which may be a relatively poor thermal conductor. Thus, much of the initial energy produced during startup of a reformer may be used to heat the alumina and heat transfer to the alumina limits rapid thermal response of the fuel cell system 10. Furthermore, some steam reforming catalysts may also have relatively low thermal conductivity, which further complicates heat transfer from the catalytic heater. Thus, in another embodiment, a thermally conductive substrate such as aluminum in the form of a porous metal or metallic sponge may be used as the catalyst. The porosity of the metal or sponge, and consequently the pressure drop, may be controlled to meet fuel processor and fuel cell system requirements.

Exemplary Interconnect

FIGS. 4A-4F illustrate an example interconnect. Combining a fuel cell and fuel processor in an engine block may employ a fuel cell system interconnect. The interconnect may be disposed at least partially between the fuel cell stack and the fuel processor to form a structural and plumbing intermediary between the two.

Combining a fuel cell and a fuel processor in a common package introduces a number of potential obstacles, such as plumbing connectivity, space, and operating temperature differences. The interconnect described herein invention overcomes many of these obstacles to facilitate a fuel cell package with reduced size and form factor.

FIG. 4A illustrates a perspective view of an interconnect 400 for use in an engine block. The interconnect 400 is illustrated coupled to the fuel processor 15 and recuperator 402. The recuperator 402 may function to transfer heat from the exhaust to the incoming reformer fuel, as discussed with reference to FIG. 4E. Interconnect 400 may be a single piece/device manifold that functions as a manifold for the fuel processor and a top plate and/or manifold for the fuel cell stack 60. Interconnect 400 may comprise of a first manifold section 450 and a second manifold section 452. The first manifold section 450 may be substantially perpendicular to the second manifold section 452 but each section is in fluid communication with the other. The first manifold section 450 may be configured to be coupled to the fuel processor 15 and the second manifold section 452 may be configured to be coupled to the fuel cell stack 20.

Interconnect 400 may include one or more materials. In one embodiment, interconnect 400 is constructed from a suitably rigid material that adds structural integrity to a fuel cell package and provides rigid connectivity between a fuel cell and fuel processor. Many metals are suitable for use with interconnect 400. In one embodiment, interconnect 400 includes a single piece of fabricated material formed from metal injection molding. Metals and high temperature plastics are suitable for use in this case. In a specific embodiment, interconnect 400 is machined from a single block of steel or aluminum. The material used in interconnects 400 may or may not be thermally conductive, depending on thermal design of the fuel cell package. By having a single manifold interconnect 400, there may be less cost and less joints to secure which makes the engine block, and hence the fuel cell, more reliable. Additionally, heat conduction may be minimized between the components by making the fluid passages with thin walls. Interconnect 400 may have minimal thermal conduction path to reduce heat losses.

Interconnect 400 includes plumbing for communicating any number of gases and liquids between a fuel cell stack and fuel processor. For the fuel cell system 10 of FIG. 1B, plumbing serviced by interconnect 400 includes 1) a hydrogen line 39 from the fuel processor to the fuel cell stack, 2) a line 38 returning unused hydrogen from the fuel cell stack back to the fuel processor, 3) an oxygen line 33 from the fuel cell stack to the fuel processor, and 4) a reformer or burner exhaust line 37 traveling from the fuel processor to the fuel cell stack. Other gas or liquid transfers between a fuel cell stack and fuel processor, in either direction, may be serviced by interconnect 400. Interconnect 400 internally incorporates all plumbing for gases and liquids it transfers to the fuel processor 15 and fuel cell stack 60 to minimize exposed tubing and package size.

Interconnect 400 includes a set of conduits 404 for fluid and gas communication between fuel cell stack 60 and fuel processor 15. As the term is used herein, a conduit refers to a channel, tube, routing port, pipe, or the like that permits gaseous or fluid communication between two locations. For interconnect 400, each conduit 404 may include a port 408 (or aperture) on each end of conduit 404. For example, one conduit 404a may include a port 408d that receives hydrogen from the fuel processor 15 on one side 401a of interconnect 400 and communicates the hydrogen—through interconnect 400—and to a port 408a on side 401b to the fuel cell stack 60. Each port 408 facilitates connectivity with interconnect 400. When assembled, each port 408 interfaces with plumbing from a fuel cell stack or fuel processor, or plumbing intermediaries therebetween.

Fuel cell 20 and fuel processor 15 may also include connections or ports that mate with ports 408 to facilitate interface and product or reactant delivery. Manifolds on fuel cell stack 60 may be coupled to ports 408 of interconnect 400. For example, port 408a may be coupled or mated to inlet hydrogen manifold 102 (FIG. 2D). FIG. 3A illustrates mating ports 209 on end plate 184 of fuel processor 15. A gasket may be disposed between end plate 184 and interconnect 400 to improve sealing.

FIG. 4B illustrates the interconnect having a cover to enclose the conduits. Interconnect 400 may have a number of sides 401. Side 401a interfaces with fuel processor 15, conduits 404 are on top side 401b, bottom side 401d interfaces with fuel cell stack 60, and side 401c services inlet plumbing to the fuel processor. Each side 401 need not be entirely flat, and may include one or more surfaces. Indeed, each side 401 may include recessed or heightened features. Different sides and surface arrangements for interconnect 400 are possible and contemplated.

Cover 406 may be disposed on side 401b to enclose conduits 404. The cover may enclose the entire side 401b of interconnect 400 or only the conduits 404 as illustrated. As illustrated in FIG. 4A, an indentation or groove 410 may be configured to received cover 406 such that it is flush with top surface 401b. Cover 406 may have a plurality of exhaust apertures 434. When the fuel cell 15 is tested, exhaust apertures 434 allow exhaust gasses to escape rather than returning to the fuel processor since the respective manifolds may be closed off as further discussed with reference to FIGS. 4F and 4G. Exhaust apertures 434 prevents excess phosphoric acid and any other exhaust gasses from going to the fuel processor 15 during fuel cell conditioning and eliminates the need to control the burner temperature in the fuel processor 15 if leftover fuel flowed through it.

FIG. 4C illustrates a perspective view of interconnect coupled to the fuel processor and fuel cell stack housing. Interconnect 400 may be coupled to a housing 418 configured to receive the fuel cell stack 60. Housing 418 may have a plurality of sides 420. Side 420a and side 420c may be parallel and opposite to each other and side 420b may be parallel and opposite to bottom side 401d of interconnect 400 thereby forming an enclosure 426 to receive the fuel cell stack 60. Side 420c may also have a plurality of heat transfer appendages 422 that permits external thermal management of internal portions of fuel cell stack 60. Alternatively, heat transfer appendages 422 may be a heat sink to permit thermal management of fuel cell 20.

In use, after the fuel cell stack (not shown) is positioned within enclosure 426, catalyst (not shown) may be disposed adjacent the fuel cell stack via opening 424. In one embodiment, after the fuel cell stack is positioned within enclosure 426, housing tabs 428 on side 420c of interconnect housing 418 may be configured to hold the catalyst in place. In another embodiment, fuel cell stack may have a plurality of tabs to hold the catalyst in place. Thus, the catalyst may be positioned adjacent the fuel cell stack and the heat transfer appendages 422. In another embodiment, catalyst may be disposed directly on or adjacent the heat transfer appendages 422.

Interconnect 400 may also have a thermowell 426 to measure gas stream temperatures. The thermowell may be a closed end tube configured to receive a probe, thermocouple wires, or the like to measure the temperature of the gas stream. The thermowell 426 may be positioned anywhere on the interconnect 400 to measure specific gas temperatures as desired by a user. Additionally, although illustrated with one thermowell, the number is not intended to be limiting as interconnect 400 may have any number of thermowells as desired.

Referring back to FIGS. 4A and 4B to discuss the delivery of gasses. Interconnect 400 communicates hydrogen from fuel processor 15 to fuel cell stack 60. A hydrogen conduit 404a in interconnect 400 then forms part of a hydrogen provision line 39 (FIG. 1C). For fuel processor 15 and fuel cell 20, hydrogen conduit 404a receives hydrogen from a hydrogen channel 209 included in fuel processor 15 (FIG. 3A) and outputs the hydrogen to port 208a. Line 39 thus includes (in order of hydrogen delivery): reformer exit via channel 209 in fuel processor 15 (FIG. 3A), conduit 204a in interconnect 400, and manifold 102 in fuel cell stack 60. Hydrogen conduit 204a includes two ports 208a and 208d (FIG. 4B). Conduit 204a passes through the material of interconnect 400 from surface 401a to surface 401b. FIG. 4D shows internal dimensions of conduit 204a. Hydrogen port 408d interfaces with hydrogen output channel 209 from fuel processor 15. A portion of a gasket seals port 408d and channel 209. Hydrogen port 408a interfaces with hydrogen manifold 102 fuel cell stack 60.

Interconnect 400 also communicates unused hydrogen and anode exhaust from fuel cell 20 back to a burner fuel processor 15. A hydrogen conduit 404c in interconnect 400 then forms part of a hydrogen return line 38 (FIG. 1C). Hydrogen conduit 404c receives unused hydrogen from manifold 104 in fuel cell stack 60 (FIG. 2D) via port 408c and outputs the anode exhaust to a burner inlet 109 in the fuel processor (FIG. 3B). Line 38 thus includes (in order of delivery): anode exit via manifold 104 in fuel cell stack 60, conduit 404c in interconnect 400, and inlet 109 in fuel processor 15. Conduit 404c includes two ports 408c and 408b (FIGS. 4A and 4B). Conduit 404c passes through the material of interconnect 400 from surface 401b to surface 401a. FIG. 4D shows internal dimensions of conduit 204c. Port 408b interfaces with an anode exhaust inlet channel 109 in fuel processor 15. A portion of a gasket seals port 408b and channel 109. Port 408c interfaces with anode exhaust manifold 104 of fuel cell stack 60.

Interconnect 400 communicates heated oxygen and cathode exhaust from fuel cell 20 to a burner in fuel processor 15. The heated oxygen may be used for catalytic combustion in the burner, and increases thermal efficiency of the package. An oxygen conduit 404b in interconnect 400 then forms part of oxygen line 33 (FIG. 1C). Oxygen conduit 404b receives heated oxygen and air from manifold 108 of fuel cell stack 60 and outputs the heated oxygen to a burner inlet in the fuel processor. Line 33 thus includes (in order of delivery): cathode exit via manifold 108 in fuel cell stack 60, conduit 404b in interconnect 400, and an inlet to the burner in fuel processor 15. Conduit 404b includes two ports 408e and 408f (FIGS. 4A and 4B). Conduit 404b passes through the material of interconnect 400 from surface 401b to surface 401a. FIG. 4D shows internal dimensions of conduit 440b. Port 408f interfaces with a burner inlet in fuel processor 15. Port 408e interfaces with cathode exhaust manifold 108 of fuel cell stack 60.

Interconnect 400 additionally communicates burner exhaust from fuel processor 15 to heat transfer appendages in fuel cell 20. The burner exhaust reacts with a catalyst disposed near the fuel cell to heat the fuel cell and expedite fuel cell start-up. A burner exhaust conduit 404d in interconnect 400 then forms part of exhaust line 35 (FIG. 1B). Conduit 404d receives burner exhaust from a burner outlet in the fuel processor and outputs burner exhaust to a heating region 262 in the fuel cell (FIG. 2B). Line 35 thus includes (in order of delivery): a burner exit in fuel processor 15, conduit 404d in interconnect 400, and heating region 262 in fuel cell 20. Conduit 404d includes two ports 408g and 408h (FIG. 4A). Conduit 404d passes through the material of interconnect 400 from surface 201a to surface that faces the body of the fuel cell. FIG. 4D shows internal dimensions of channel 206d. Port 208g interfaces with a burner outlet in fuel processor 15. A portion of a gasket seals port 208g and the burner outlet. Port 208h (not illustrated) opens to region 262 in the fuel cell 20.

Interconnect 400 is also responsible for fuel source delivery to fuel processor 15. A reformer fuel source inlet 81 receives methanol from a fuel source feed (pump 21b and an upstream storage device 16, see FIG. 1B) and includes a conduit 406e internal to interconnect 400 that delivers the methanol to a boiler in the fuel processor that heats the methanol before delivery to the reformer. A burner fuel source inlet 404f receives methanol from a second fuel source feed (a second pump 21a and upstream storage device 16) and includes a conduit 406f internal to interconnect 400 that delivers the methanol to a boiler in the fuel processor that heats the methanol before delivery to the catalytic burner.

Interconnect 400 may also have an oxygen conduit 404d that forms part of conduit 31, which draws air from the ambient room. Oxygen conduit 404d may have a port 408d that opens to an oxygen manifold 106 (FIG. 2D) in fuel cell stack 60 that is configured to deliver inlet oxygen and ambient air to a channel field 72 on each bi-polar plate 44 in stack 60.

In general, interconnect 400 may include any suitable number of conduits for communicating fluids and gases between a fuel cell and fuel processor. From 1 to about 8 conduits is suitable for many micro fuel cell systems and packages. Each conduit may be dedicated to a particular gas or fluid. Dedicated conduits may be responsible for: oxygen, hydrogen, burner or reformer exhaust, methanol or another fuel source, air, or any other reactant or process gas or liquid used in a fuel processor or fuel cell. It is understood that some of these substances may go in either direction (or both) between a fuel cell and a fuel processor.

In general, a conduit 404 may communicate a gas or liquid between any portion or portions of a fuel cell stack or fuel processor. For example, a conduit may receive a gas from a dedicated manifold in a fuel cell stack or fuel processor. Alternatively, a conduit may deliver a gas to a region within a fuel cell stack, such as a volume that includes one or more heat transfer appendages. The conduits 404 may be variably configured according to design demands. In one embodiment, an interconnect and its conduits 404 are designed and configured to reduce volume of the integrated fuel cell package. In another embodiment, conduits 404 are designed and configured to align with existing fluid channels and conduits of a fuel cell stack and fuel processor.

A gasket may also be employed to interface between interconnect 400 and the fuel cell stack 60 or between interconnect 400 and fuel processor 15. For example, a gasket may be disposed during assembly between end plate 184 of fuel processor 15 and interconnect 400.

One issue that arises with combining a fuel cell stack and fuel processor in a common and compact package is operating temperature differences between the two. Depending on the specific fuel cell, processor, and their respective catalysts, temperature differences between the two structures in a compact package may vary significantly. For example, one suitable fuel processor 15 operates above 250° C., while fuel cell 20 typically operates about 190° C. (or below). Putting the two objects in close proximity introduces potential heat transfer, and resulting thermal efficiency losses in the fuel processor if the heat transfer cannot be controlled.

Interconnect 400 is designed to reduce heat transfer between a fuel processor and a fuel cell stack. In one embodiment, the interconnect serves as an insulation for heat transfer between the fuel cell stack and the fuel processor and includes a low thermal conductance material. In another embodiment, the interconnect contains a minimal amount of material in contact with the fuel cell stack and/or fuel processor, which minimizes thermal conduction between the two components via the interconnect. This reduces material restrictions on interconnect 400.

FIG. 4E illustrates the interconnect having side heat transfer appendages. As stated above, recuperator 402 may function to transfer heat from the exhaust to the incoming reformer fuel. As such, the recuperator 402 may utilize waste heat to vaporize fuel rather than generating additional heat. Using waste heat may produce between about a 5%-45% decrease in burner fuel reduction, which is a gain in efficiency of the fuel processor since no heat is required to be generated.

In use, any remaining burner exhaust may be directed from recuperator 402 to the heat transfer appendages 430. Alternatively, a blower may run ambient air, in the direction of arrow A, through the catalyst on the heat transfer appendages 430 to heat the fuel cell stack. Catalyst, as discussed above, may be positioned adjacent or directly on the heat transfer appendages 430.

In one embodiment, heat transfer appendages may be coupled to the interconnect 400 via any attachment device, such as screws 432. In another embodiment, heat transfer appendages may be coupled to the fuel cell stack (not shown).

Although illustrated with a recuperator, use of a recuperator is not necessary as illustrated in FIGS. 4B and 4C. When used without a recuperator, exhaust gasses may be routed to a burner positioned between the fuel cell stack and fuel processor.

FIGS. 4F and 4G illustrate an example test adaptor. FIG. 4F illustrates a close-up view of conduits 404 and screw holes 215. Test adaptor 437 may be secured to interconnect 400 via screws 436 in screw holes 215 to isolate the fuel processor 15 from the fuel cell stack 60. The test adaptor 437 may seal conduits 404 on side 401b to isolate the fuel cell processor for testing. This allows a user to exclusively test the fuel processor. In one embodiment, the apertures 438 of test adaptor 437 may be sealed with test probes. In another embodiment, apertures 438 may be designed to securely plug or seal conduits 404. In yet another embodiment, apertures 438 may be sealed with a sealing member, such as a screw or single ended tube, thereby allowing a user to test different components of the fuel processor 15.

Interconnect 400 has multiple advantages. Typically, a fuel cell system 10 includes significant amount of plumbing between a fuel cell and fuel processor. Such plumbing consumes considerable space. One advantage of interconnect 400 is that it reduces the size of engine block 12 containing both a fuel processor and fuel cell stack by eliminating numerous tubes and additional plumbing associated with a disparate fuel cell and fuel processor. Interconnect 400 also avoids the need for brazing metal tubes, which affects manufacture. Although the present invention may include one or more brazed metal tubes, reducing the number of pipes with interconnect 400 decreases manufacturing complexity.

While interconnect 400 has been described with respect to a single separate structure that separably attaches to both a fuel cell and a fuel processor, it is understood that the interconnect may be included as an integral part of a fuel cell, or as an integral part of a fuel processor, that the other attaches to.

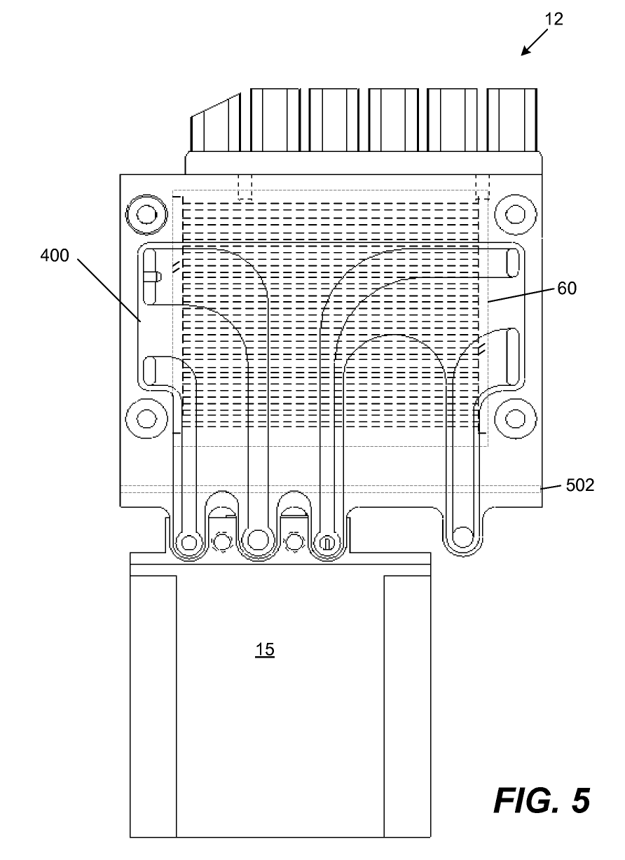

FIG. 5 illustrates a top view of an example engine block. Engine block 12 may have a fuel processor 15 and fuel cell stack 60 in close proximity to each other. The fuel cell stack 60 and fuel processor 15 may be in fluid communication via the manifolds in interconnect 400. Thus, efficient thermal management of engine block 12 is important to prevent degradation, leakage, and the like of engine block 12. For efficient thermal management, in one embodiment, fuel cell stack 60 may operate at a temperature that is higher than or equal to the temperature of fuel processor 15. In one embodiment, the temperature variance or differential between the fuel cell stack 60 and fuel processor 15 may be between about 0° C.-40° C. In another embodiment, the temperature differential may be between about 0° C.-150° C.

A shield 502 may be used to thermally isolate the fuel cell burner from the fuel cell stack 60 for thermal management and efficiency of engine block 12. Shield 502 may be made from any thermally conductive material such as ceramic, mica, stainless steel, and the like.

Exemplary Fuel Cell Stack Heater

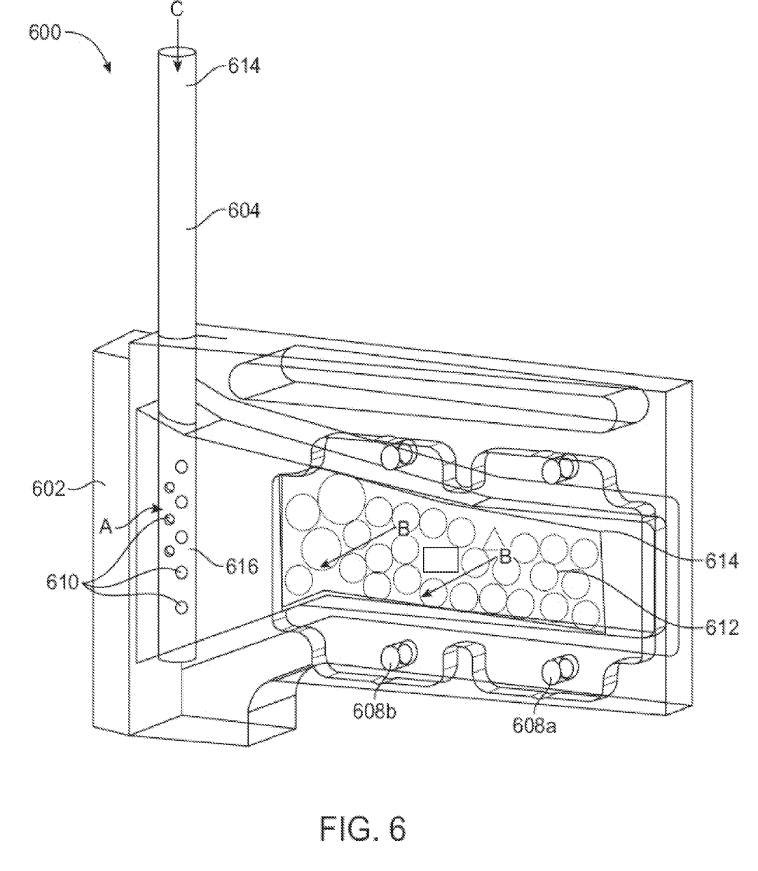

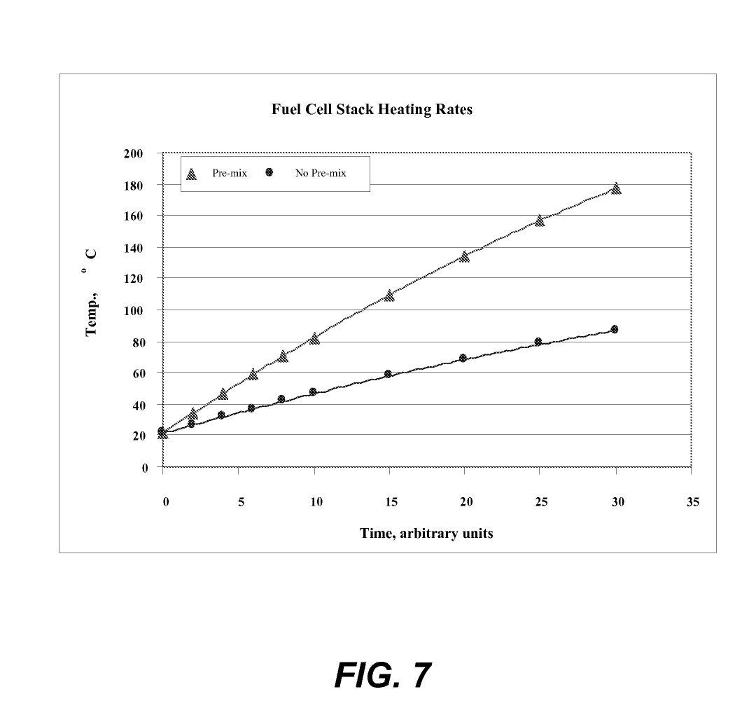

FIG. 6 illustrates an example fuel cell stack heater. The fuel cell stack heater 600 may have a diffuser 604 and a catalyst bed 612. Combustion fuel may enter the diffuser 604 in the direction of arrow C and air may enter the diffuser 604 in the direction of arrow A. FIG. 7 is a graph of fuel cell stack heating rates. Pre-mixing combustion fuel and air prior to contact with the catalyst bed 612 may increase the efficiency of heating the fuel cell stack. As illustrated in FIG. 7, premixing the combustion fuel and air provides for a higher temperature in a shorter time period than if the gasses were not pre-combined. A diffuser 604 may be used to pre-mix the combustion fuel and air before entering the catalyst bed 612.

Combustion fuel may enter a top end 614 of the diffuser 604 in the direction of arrow C and air may enter the diffuser 604 at the bottom end 616 in the direction of arrow A. The fuel cell stack heater 600 may be coupled to an air source 602 such as a compressor, blower, fan, or the like. The outlet or output of the air source 602 may be coupled to the heater 600 such that the air is directed in the direction of arrow A. The air source 602 should be strong enough to force the gasses to penetrate into catalyst bed 612.

The combustion fuel may travel down the diffuser 604 toward the bottom end 616 of the diffuser 604 where it contacts the air flow. The diffuser 604 may be used to affect the pre-mixing of the combustion fuel and air. In one embodiment, screens (not shown) may be placed at the first end 614 and/or at the second end 614 to result in a turbulent flow of each gas. The turbulence may result in the mixing of the combustion fuel with the air.

In another embodiment, a plurality of perforations or apertures 610 may be positioned at the bottom end 616 of the diffuser 604. The use of apertures 610 may result in a laminar mixing of the combustion fuel with air. Laminar mixing of the gasses may be more desirable than turbulent mixing due to the flow regime of the gasses. Both the combustion fuel and air may be laminated (e.g. divided) then recombined so that the laminates of the gases alternate. The strategic placement and design of the diffuser 604 may improve the mixing of the gasses. For example, the location of the apertures 610 and the direction of flow of the combustion fuel from the apertures may be important. In one embodiment, the apertures 610 may be between about 45° and 85° or between about 275° and 315° may provide efficient mixing from a straight tube diffuser. Additionally, the diameter, shape, and size of the apertures 610 may be varied to maintain a constant pressure drop throughout the diffuser or to adjust the combustion fuel flow profile for improved mixing with the air.

In still another embodiment to laminate the gasses, each gas may be divided into chambers or strips separated with a solid wall. Each wall may have a gap, narrow opening, plurality of apertures, or the like to allow for entry into the other gas chamber. The gap may be perpendicular to the flow of the gasses. Thus, the gasses may be combined and released through the gaps. The width, length, and shape of the gaps may be varied to achieve a desired mixing result or to maintain a constant pressure drop.

When the combustion fuel and air are mixed, the mixture may be forced into the catalyst bed 612 to react with the catalyst. The catalyst may be any type, shape, and size of catalyst as illustrated with the use of square, triangle, large circular and small circular catalyst. The catalyst may be any type of catalyst as discussed above, such as Pt or Pd. The catalyst may be inserted into the catalyst bed 612 via catalyst inlet 608a, 608b which may also vary in size an diameter to accommodate the various catalysts. The catalyst bed 612 may be held in place by any means such as a metal screen 614. In one embodiment, the catalyst may be a microlith such as those made by Precision Combustion Inc. of North Haven, Conn. A microlith may be used since it is designed to function at short contact times (i.e. potentially small size) and may have a low pressure drop.

The pre-mixed mixture of combustion fuel and air may be forced into the catalyst bed to react with the catalyst. Since the heater is a sealed structure and the gasses are forced directly into the catalyst bed, all the gasses reach the catalyst bed 612, which increases the efficiency of catalytic combustion in the heater 600.

The heated airflow may flow outwardly in the direction of arrow B through the metal screen 614 to heat the fuel cell stack. The fuel cell stack heater 600 may be coupled to the fuel cell stack so that the catalyst bed 612 may be offset from the fuel cell stack. Use of the heater 600 may increase heating efficiency of the fuel cell stack since the catalyst bed 612 is offset from the fuel cell stack and the hot combustion gasses are directed to impinge directly on the fuel cell stack.

The fuel cell heater 600 may provide for an efficient use of combustion gases since all the gasses reach the catalyst bed 612 and do not leak to the atmosphere which may result in waste and higher usage of combustion gases. The fuel cell heater 600 also provides better contact of pre-mixed gases with the catalyst bed 612 since the catalyst develops a higher temperature more quickly and the energy is transferred directly to the fuel cell stack to allow the fuel cell stack to reach operating temperature quicker.

Furthermore, use of the fuel cell heater 600 provides for less emission. Catalytic combustion provides heat for the reforming process and lessens emissions. Emissions from the fuel cell system may include water, carbon dioxide, and unconsumed air. Moreover, the fuel cell heater 600 may be split into one or more segments to ensure the exhaust products are fully oxidized. For example a second segment of the fuel cell heater 600 may be located down stream of the first segment and be plumbed so as to receive the exhaust produces from the first segment and also the air stream from a secondary air source, such as a fuel cell cooling air stream thereby ensuring that the fuel cell exhaust products meet regulatory standards. For example, International Electrotechnical Commission (IEC) standard 62282-6-1 Ed.1/PAS emissions, which governs the use and transport of portable methanol fuel cells on commercial aircraft, lists the following maximum emissions rates and concentration limits for a 1 m³ air volume with 10 air changes per hour. Thus, the fuel cell heater 600 may ensure that the IEC standard is met as follows:

TABLE 1

| | |
|---|---|
| Concentration Limit | Emission Rate Limit |

| Water | Unlimited | | No limit | |
|---|---|---|---|---|
| Methanol | 260 | mg/m³ | 2600 | mg/hour |
| Formaldehyde | 0.1 | mg/m³ | 0.6 | mg/hour |
| CO | 29 | mg/m³ | 290 | mg/hour |
| CO₂ | 9 | g/m³ | 60000 | mg/hour |
| Formic Acid | 9 | mg/m³ | 90 | mg/hour |
| Methyl Formate | 245 | mg/m³ | 2450 | mg/hour |

Exemplary Fuel Cell System Assembly

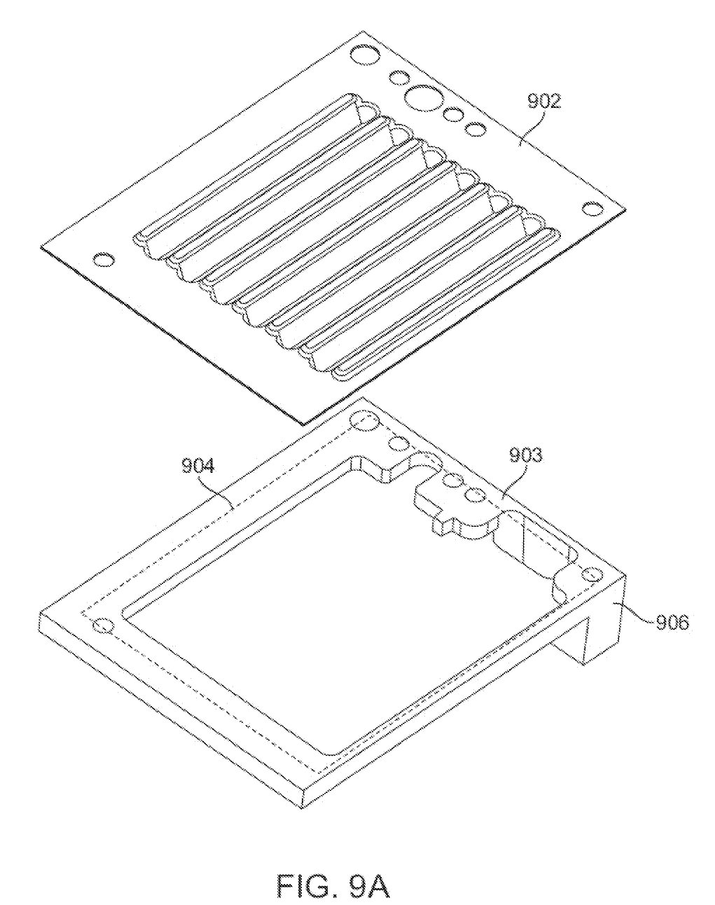

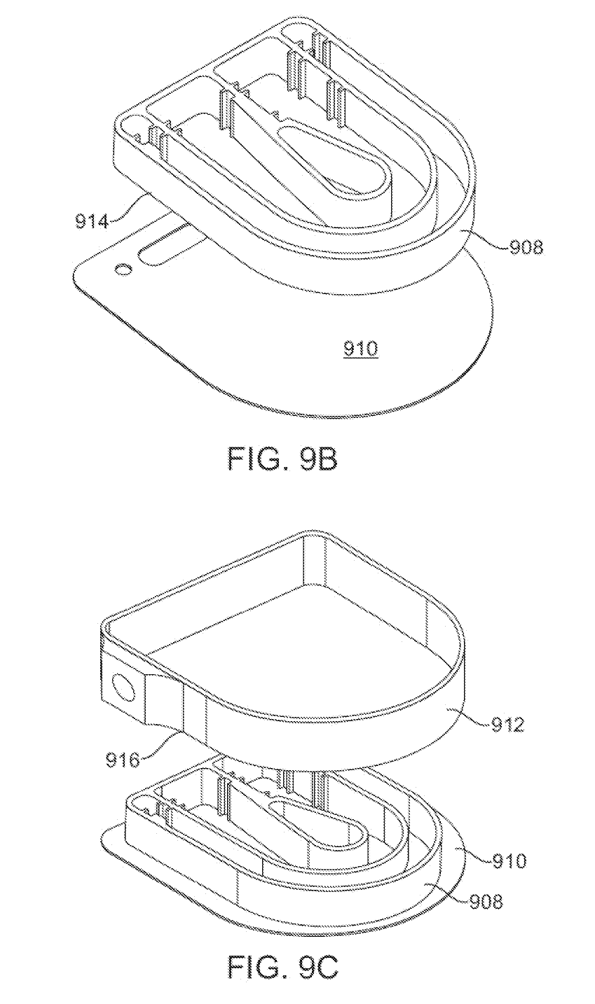

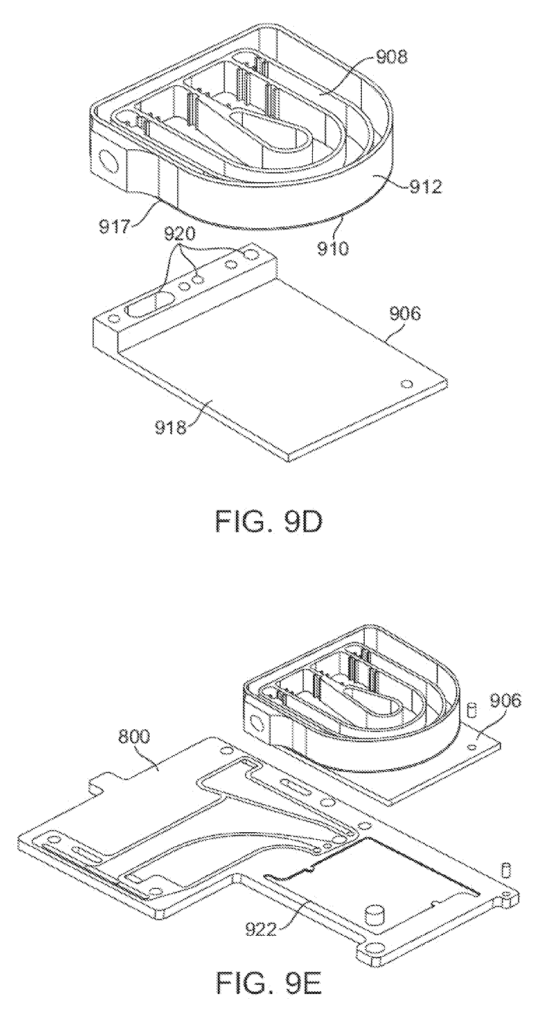

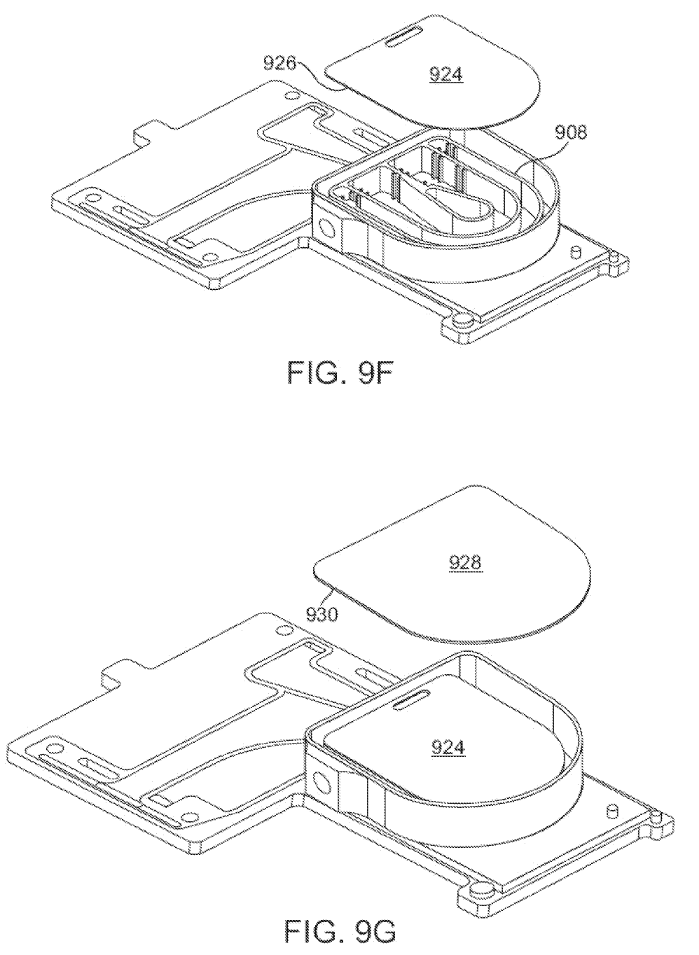

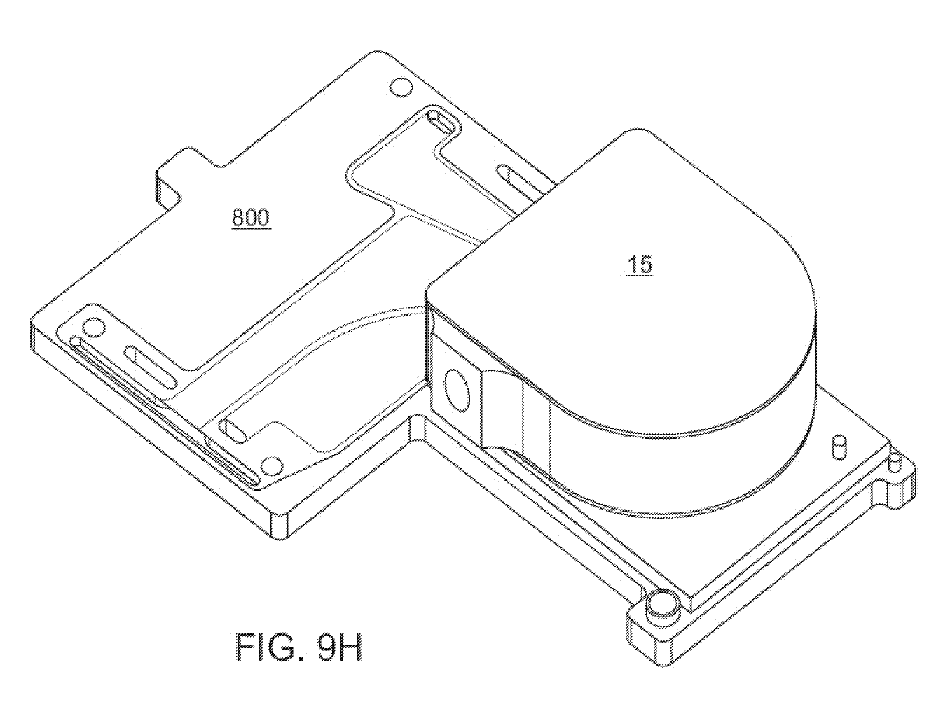

A fuel cell system may be designed or assembled with permanent joints. By sealing the system with certain joining techniques, the system may have a robust, hermetic seal. The joints may be created through laser-welding, brazing, ultrasonic welding, or other welding processes. Components of the fuel cell system may be designed as layers (see, FIGS. 9A-9H) to facilitate or join the joints through welding. This may allow for several lap-welds as the design is stacked up. Any of the joints that cannot be lap-welded may be brazed prior to assembly.

By welding the joints together, a user may have more flexibility for directing fluids in the fuel cell system. The flow passage dimensions may be designed and tailored to achieve desired pressure drops and velocities, and the fluid passageways may be parallel to the layers in a system. In one embodiment, because there are two fuel cell inlets, two fuel cell outlets, three fuel processor inlets and two fuel processor outlets, there may be various flow passages to be designed into the fuel cell system without cross-over leaks between other flow passages. With a layered design, the passages may be formed into one integral plate with flow passages on both surfaces that are sealed and enclosed with a thin layer cover that may be laser-welded in place.

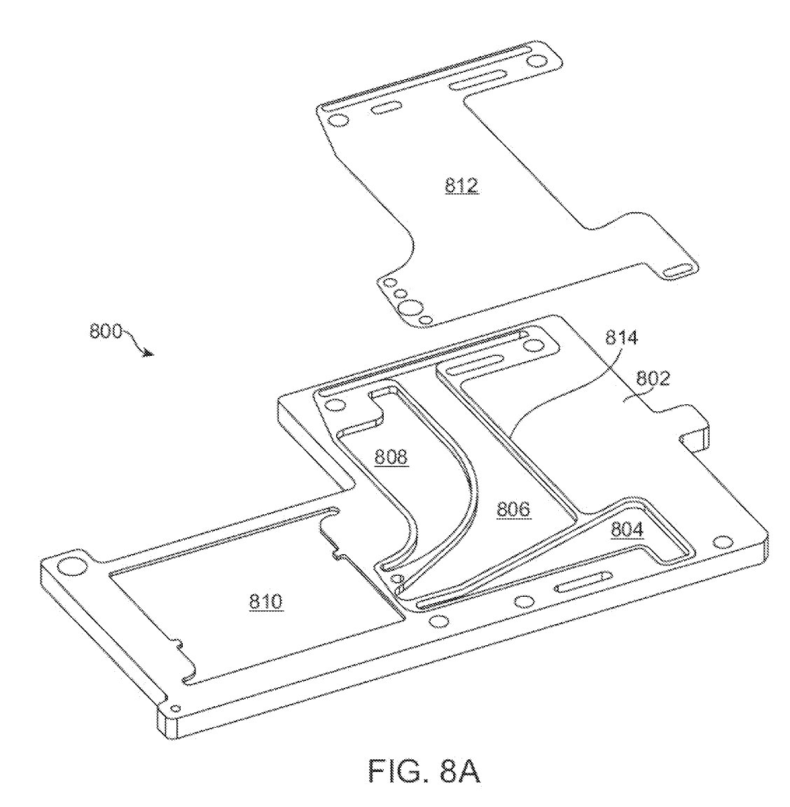

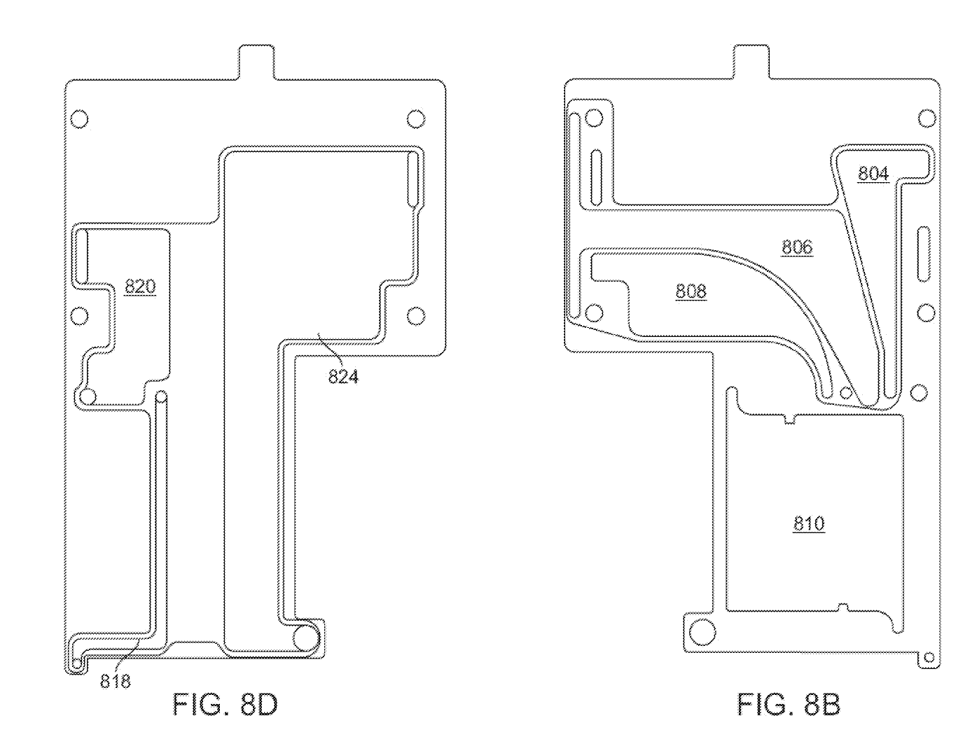

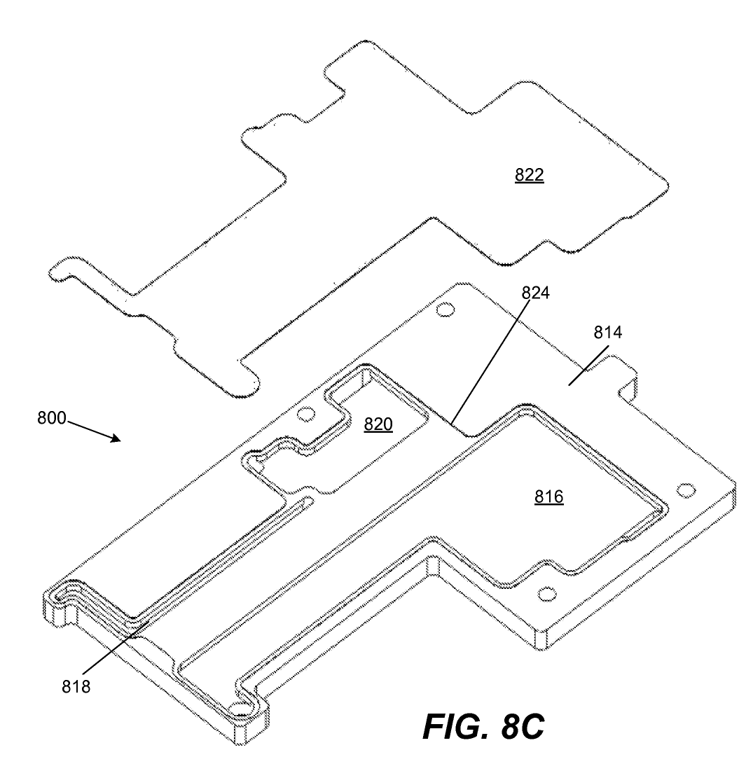

FIGS. 8A-8D illustrate an example fuel cell system assembly. FIG. 8A is a perspective view of a top surface of a system manifold and FIG. 8B is a top view of the fluid passageways on the top surface of the system manifold of FIG. 8A. The system manifold 800 may be one continuous manifold for the fuel processor and fuel cell. The system manifold 800 may have a plurality of fluid passageways formed therein in one integral plate. The fluid passageways may be sealed with top cover 812 being welded along seal or joint path 814 on the top surface 802 of the system manifold 800.

As stated above, any number of fluid passageways may be designed. In one embodiment, as illustrated in FIGS. 8A and 8B, the top surface 802 of system manifold 800 may have an inlet hydrogen passageway 804 configured to deliver inlet hydrogen gas to the fuel cell stack. The system manifold 800 may also have a fuel processor burner exhaust passageway 806 and a reformer passageway 808. As an example, in use, the hydrogen passageway 804 may be in fluid communication with inlet hydrogen manifold 102 (FIG. 2D) of fuel cell stack 60.

The top surface 802 may also have a heat exchanger socket 810 configured to receive a heat exchanger or recuperator of the fuel. In one embodiment, the heat exchanger may be coupled to the fuel processor. Example heat exchangers are discussed in detail in co-pending application Ser. No. ______, filed ______, entitled “Fuel Processor For Use In a Fuel Cell System”, (Attorney Docket ULTRP022) which is incorporated herein by reference for all purposes and will not be discussed herein for brevity.

FIG. 8C is a perspective view of the bottom surface of a system manifold and FIG. 8D is a top view of the fluid passageways on the bottom surface of the system manifold of FIG. 8C. The system manifold 800 may have a plurality of passageways formed therein on the bottom surface 814 of system manifold 800. The system manifold 800 may have an air passageway 816, a burner passageway 818, and a cathode exhaust passageway 820. The fluid passageways may be sealed with bottom cover 822 being welded along seal or joint path 824 on the top surface 814 of the system manifold 800. As an example, in use, the air passageway 816 may be in fluid communication with oxygen manifold 106 (FIG. 2D) to deliver inlet oxygen and ambient air to the fuel cell stack.

In addition to the system manifold 800, other components of the fuel cell system may benefit from a laser-welded seal. The fuel processor often contains catalysts that degrade at extreme temperatures of most brazing and welding processes. However, laser-welding is a fast process that only heats a small area that will not exceed the maximum service temperature of the catalysts. Likewise, the electrical feed-through in the fuel processor may be sensitive to higher temperatures depending on the materials used. Thus, the part may be effectively sealed to the outer body of the fuel processor with laser-welding.

In general, a metal-to-metal joint may improve the heat transfer between the different fuel cell system components because the pieces become one conductive alloy at the joint. This benefits most components, including the heat exchanger, which depends on heat transfer from a hot gas to a cold liquid.

Furthermore, these metal joining processes may be more conducive to high volume manufacturing practices. Gaskets and fasteners are eliminated, which minimizes the cost of materials. These joining processes are also amenable to automation, which may improve the reproducibility of the seal and the speed at which the components are assembled. Laser-welding and/or brazing may be good methods by which a fuel cell system may be manufactured.

FIGS. 9A-9H illustrate an example fuel cell system assembly. As illustrated in FIG. 8A, top cover 812 may be welded to system manifold 800 along joint path 814. As illustrated in FIG. 8C, bottom cover 822 may be welded to system manifold 800 along joint path 824. FIG. 9A illustrates a perspective view of an example heat exchanger. The heat exchanger 902 may be welded along joint path 904 to the bottom surface 903 of fuel processor interface 906 joint path may match with the outline of heat exchanger 902. FIGS. 9B-9D illustrate the assembly of an example fuel processor. As illustrated in FIG. 9B, monolith structure 908 may be welded to end plate 910 along joint path 914 and regenerator 912 may be welded to end plate 910 along joint path 916 around monolith structure 908 as illustrated in FIG. 9C. Joint path 914 may match with the outline of monolith structure 908 and joint path 916 may match with the outline of regenerator 912. Monolith structure 908 and regenerator 912 are further described and discussed in co-pending application Ser. No. ______ (Attorney Docket ULTRP022) and will not be discussed herein for brevity.

As illustrated in FIG. 9D, end plate 910 may be welded to a top surface 918 of fuel processor interface 906 along joint path 917 such that conduits 920 on fuel processor interface 906 align with the corresponding ports (not shown) on end plate 910. Joint path 917 may match with the outline of end plate 910. Once assembled together, the fuel processor may be welded to system manifold 800 along joint path 922 as illustrated in FIG. 9E. Joint path 922 may match with the outline of fuel processor interface 906. End plate 924 may be welded onto monolith structure 908 along joint path 926 as illustrated in FIG. 9F and end plate 928 may be joined to regenerator 912 along joint path 930 as illustrated in FIG. 9G. Joint path 926 may match with the outline of end plate 924 and joint path 930 may match with the outline of end plate 928. FIG. 9H illustrates the fuel processor 15 assembled on the system manifold 800. Thus, layering each component of the fuel processor 15 facilitates the joining process and functionality of the fuel cell system.

As stated above, in one embodiment, system 10 may be sold as a physical engine block 12 plus specifications for interfacing with the engine block 12. The specifications may include desired cooling rates, airflow rates, physical sizing, heat capture and release information, plumbing specifications, fuel inlet parameters such as the fuel type, mixture and flow rates, etc. This permits engine block 12 to be sold as a core component employed in a wide variety of devices determined by the engine block purchaser. Sample devices include: portable fuel cell systems, consumer electronics components such as laptop computers, and custom electronics devices. The engine block may be directly installed into a electronics device such as a ruggedized laptop computer for example, and serve as the power generating portion of the on-board power supply in conjunction with a battery for energy storage. In one embodiment, the engine block may also be configured with a hybrid battery and installed into a “tethered power supply” which supplies power to the load of the end user's choosing. In another embodiment, the engine block may be installed into a battery charger to allow for charging of one or more military or emergency responder radio batteries.

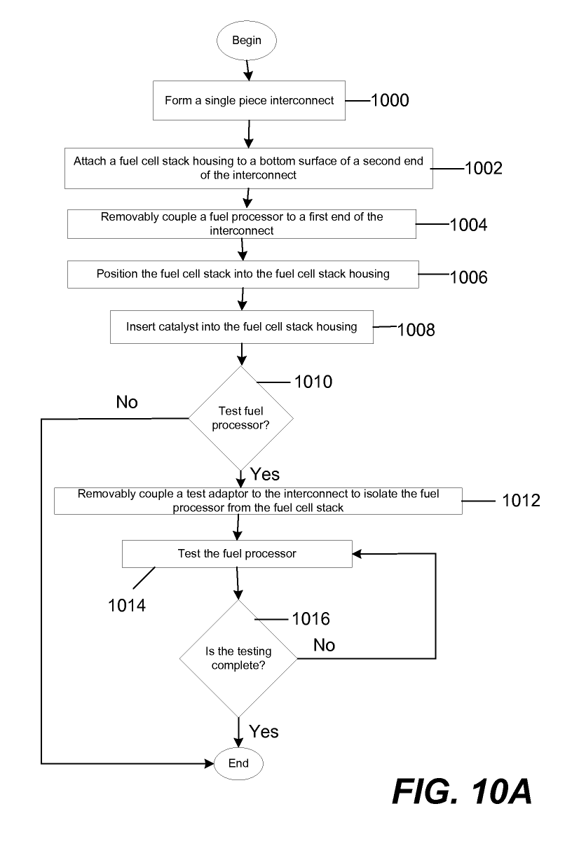

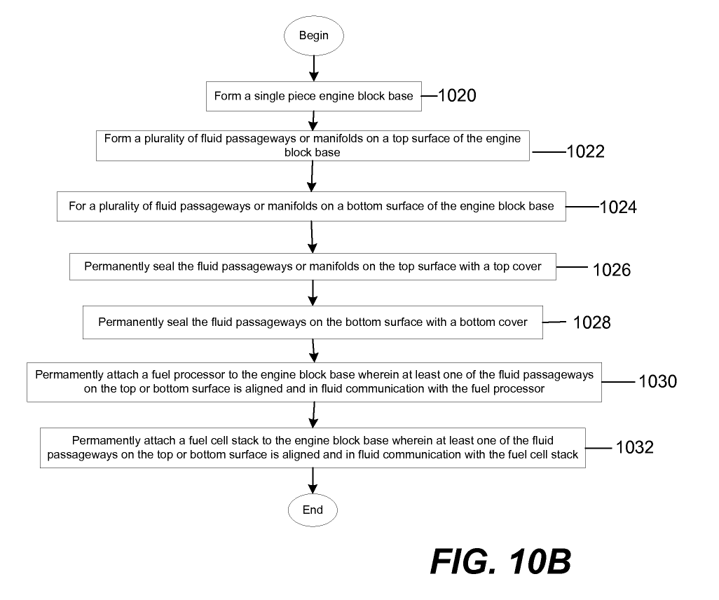

FIGS. 10A and 10B illustrate example methods for manufacturing an engine block. Referring now to FIG. 10A, a single piece interconnect may be formed at 1000. The interconnect may be disposed at least partially between the fuel cell stack and the fuel processor to form a structural and plumbing intermediary between the two. Interconnect may be a single piece/device manifold that functions as a manifold for the fuel processor and a top plate and/or manifold for the fuel cell stack. Interconnect may have a first end and a second end, wherein the first end is substantially perpendicular to the second end. Interconnect may be injection molded or formed from any other similar methods.

A fuel cell stack housing may be coupled to the bottom surface of a second end of the interconnect at 1002. The fuel cell stack housing may be designed or configured to receive the fuel cell stack. The housing may have a plurality of sides forming a partial enclosure to house the fuel cell stack. Additionally, one side of the housing may have a plurality of heat transfer appendages that permits external thermal management of internal portions of the fuel cell stack. The heat transfer appendages may be positioned the side away from the fuel processor. Alternatively, heat transfer appendages may be a heat sink.

The fuel processor may be removably coupled at a first end of the interconnect at 1004 and the fuel cell stack may be positioned within the fuel cell stack housing at 1006. Interconnect includes a set of conduits for fluid and gas communication between fuel cell stack and fuel processor. As the term is used herein, a conduit refers to a channel, tube, routing port, pipe, or the like that permits gaseous or fluid communication between two locations. For example, one conduit may receive hydrogen from the fuel processor and communicates the hydrogen—through interconnect—to the fuel cell stack. Thus, when assembled, fuel processor and fuel cell stack may align with the conduits on interconnect to allow the fuel cell stack and fuel processor to be in fluid communication with each other.

In one embodiment, catalyst may be disposed within the fuel cell stack housing at 1008. In one embodiment, after the fuel cell stack is positioned within the housing enclosure, the housing may have tabs within the enclosure to hold the catalyst in place. In another embodiment, fuel cell stack may have a plurality of tabs to hold the catalyst in place. Thus, the catalyst may be positioned adjacent the fuel cell stack and the heat transfer appendages.

The fuel processor may need to be tested at 1010. A test adaptor may be coupled to the interconnect to isolate the fuel processor from the fuel cell stack at 1012 to test the fuel processor at 1014. The test adaptor may be secured to interconnect via any means such as a screw. The test adaptor may seal the conduits to exclusively isolate the fuel cell processor for testing. In one embodiment, the apertures of the test adaptor may be sealed with test probes. In another embodiment, the apertures of the test adaptor may be plugs designed and configured to securely plug the conduits. In yet another embodiment, apertures of the test adaptor may be sealed with a sealing member, such as a screw.

FIG. 10B illustrates another example method for manufacturing an engine block. A single engine block base may be formed at 1020. The engine block base may be formed by injection molding or formed from any other similar methods. A plurality of fluid passageways or manifolds may be formed on a top surface of the engine block base at 1020. The fluid passageways may be formed partially through the depth of the engine block base. This allows fluid passageways or manifolds to also be formed on a bottom surface of the engine block base at 1024. This forms a system manifold having a plurality of fluid passageways formed therein on one integral plate.

The fluid passageways or manifolds on the top surface may be permanently sealed with a top cover at 1026 and the fluid passageways on the bottom surface may be permanently sealed with a bottom cover at 1028. The fluid passageways may be sealed with a permanent seal through laser-welding, brazing, ultrasonic welding, or other welding processes. Lap-welds may also be used and any of the joints that cannot be lap-welded may be brazed. By sealing the engine block with certain joining techniques, the fuel cell system may have a robust, hermetic seal. Furthermore, by welding the joints together, a user may more flexibility for directing fluids in the system. The flow passage dimensions may be tailored to a required pressure drop and velocities, and these fluid paths may be parallel to the layers in a system. Additionally, the use of gaskets and fasteners are eliminated, which minimizes the cost of materials.

A fuel processor may be permanently attached to the engine block base wherein at least one of the fluid passageways on the top or bottom surface of the engine block base is aligned and in fluid communication with the fuel processor at 1030. Components of the fuel cell processor may benefit from permanently attaching the engine block to the engine block base. For example, the fuel processor may contain catalysts that degrade at extreme temperatures of most brazing and welding processes. However, laser-welding is a fast process that only heats a small area that will not exceed the maximum service temperature of the catalysts. Likewise, the electrical feed-through in the fuel processor may be sensitive to higher temperatures depending on the materials used. Thus, the part may be effectively sealed to the outer body of the fuel processor with laser-welding.

The fuel cell stack may be permanently attached to the engine block base wherein at least one of the fluid passageways on the top or bottom surface if the engine block base is aligned and in fluid communication with the fuel cell stack at 1032. Permanently sealing the fuel processor and fuel cell stack to the engine block base renders the processes more conducive to high volume manufacturing practices. The joining processes are amenable to automation, which may improve the reproducibility of the seal and the speed at which the components are assembled. Laser-welding and/or brazing may be good methods by which a fuel cell system may be manufactured.

While embodiments and applications of this invention have been shown and described, it would be apparent to those skilled in the art having the benefit of this disclosure that many more modifications than mentioned above are possible without departing from the inventive concepts herein.

What is claimed is:

1. An engine block, comprising:
an interconnect having:
a first manifold section;
a second manifold section perpendicular to the first manifold section,
the first manifold section and the second manifold section having a plurality of conduits to receive a gas flow,
wherein the first manifold section and the second manifold section are formed from a single manifold device;
a fuel cell stack housing coupled to the second manifold section to receive a fuel cell stack; and
a fuel processor coupled to the first manifold section,
wherein the fuel cell processor and the fuel cell stack operate at substantially the same temperature.

2. The engine block of claim 1, further comprising a fuel cell heater coupled to the fuel cell stack.

3. The engine block of claim 2, wherein the fuel cell heater further comprises:
a diffuser configured to receive a combustion fuel flow;
an air source to supply an air flow to be mixed with the combustion fuel flow to form a combustion gas mixture; and
a catalyst bed configured to receive the combustion gas mixture;
wherein the air source forces the combustion gas mixture into the catalyst bed.

4. The engine block of claim 1, wherein the fuel cell stack further comprises a plurality of heat transfer appendages.

5. The engine block of claim 1, wherein the fuel cell stack housing further comprises a plurality of heat transfer appendages.

6. The engine block of claim 5, further comprising a plurality of catalyst disposed adjacent the plurality of heat transfer appendages.

7. The engine block of claim 3, wherein the diffuser further comprises:
a first screen at a diffuser first end; and
a second screen at a diffuser second end,
wherein a turbulent flow results to form the combustion gas mixture.

8. The engine block of claim 3, wherein the diffuser further comprises a plurality of apertures at a diffuser second end,
wherein a laminate flow results to form the combustion gas mixture.

9. The engine block of claim 3, wherein the diffuser further comprise a plurality of laminating shields having at least one gap,
wherein a laminate flow results to form the combustion gas mixture.

10. The engine block of claim 3, wherein the catalyst bed further comprises at least one microlith.

11. The engine block of claim 1, further comprising a shield disposed between the fuel cell processor and the fuel cell stack.

12. An engine block, comprising:
an engine block base formed from a single plate having:
a top surface, a bottom surface, the top surface having a first end, and a second end;
a plurality of fluid passageways formed in the top surface and the bottom surface;
a fuel cell stack permanently sealed to the second end; and
a fuel processor permanently sealed to the first end,
wherein the fuel cell stack and the fuel processor are in fluid communication via the plurality of fluid passageways.

13. The engine block of claim 12, wherein the fuel cell processor and the fuel cell stack operate at substantially the same temperature.

14. The engine block of claim 12, further comprising a fuel cell heater coupled to the fuel cell stack.

15. The engine block of claim 14, wherein the fuel cell heater further comprises:
a diffuser configured to receive a combustion fuel flow;
an air source to supply an air flow to be mixed with the combustion fuel flow to form a combustion gas mixture; and
a catalyst bed configured to receive the combustion gas mixture;
wherein the air source forces the combustion gas mixture into the catalyst bed, and wherein the air source, the diffuser, and the catalyst bed form an enclosed heater.

16. The engine block of claim 15, wherein the diffuser further comprises:
a first screen at a diffuser first end; and
a second screen at a diffuser second end,
wherein a turbulent flow results to form the combustion gas mixture.

17. The engine block of claim 15, wherein the diffuser further comprises a plurality of apertures at a diffuser second end to form a laminate flow to form the combustion gas mixture.

18. The engine block of claim 15, wherein the diffuser further comprises a plurality of laminating shields having at least one gap to form a laminate flow to form the combustion gas mixture.

19. The engine block of claim 15, wherein the catalyst bed further comprises at least one microlith.

20. A method for manufacturing an engine block, comprising:
forming an interconnect having a plurality of conduits, each conduit configured to receive a gas flow, the interconnect having a first end substantially perpendicular to a second end;
attaching a fuel processor to a first end of the interconnect, the fuel processor having a plurality of ports aligned with at least one of the plurality of conduits; and
attaching a fuel cell stack housing to a second end of the interconnect, the housing configured to receive a fuel cell stack, the fuel cell stack having a plurality of ports aligned with at least one of the plurality of conduits,
wherein the fuel processor and the fuel cells stack operate at substantially the same temperature.

21. The method of claim 20, further comprising disposing a plurality of catalyst in the fuel cell stack housing.

22. The method of claim 20, further comprising testing the fuel processor.

23. The method of claim 22, wherein the testing further comprises securing the plurality of conduits with a test adaptor to isolate the fuel processor.

24. The method of claim 20, further comprising heating the fuel cell stack with a fuel cell stack heater.

25. A method for manufacturing an engine block, comprising:
forming a single engine block base having a top surface and a bottom surface, the top surface having a first end and a second end;
creating a plurality of fluid passageways on the top surface and the bottom surface;
permanently attaching the plurality of fluid passageways with a top cover on the top surface and a bottom cover on the bottom surface;
permanently attaching a fuel processor to the first end of the engine block, the fuel processor having a plurality of fuel processor components; and
permanently attaching a fuel cell stack to the second end of the engine block,
wherein a plurality of ports on the fuel processor align with at least one of the plurality of fluid passageways, and wherein a plurality of ports on the fuel cell stack align with at least one of the plurality of fluid passageways such that the fuel processor and the fuel cell stack are in fluid communication.

26. The method of claim 25, further comprising operating the fuel cell stack and the fuel processor at substantially the same temperature.

27. The method of claim 25, further comprising layering the plurality of fuel processor components to assemble the fuel processor.

28. The method of claim 25, wherein the permanently attaching further comprises laser welding a joint path to form a permanent seal.

29. An interconnect for use in an engine block, comprising:
a first manifold section;
a second manifold section perpendicular to the first manifold section,
the first manifold section and the second manifold section having a plurality of conduits to receive a gas flow,
wherein the first manifold section and the second manifold section are formed from a single manifold device.

30. The interconnect of claim 29, wherein the first manifold section is coupled to a fuel cell processor.

31. The interconnect of claim 29, further comprising a fuel cell stack housing coupled to the second manifold section, wherein the housing is configured to receive a fuel cell stack.

32. The interconnect of claim 31, further comprising a plurality of heat transfer appendages coupled to an outer surface of the fuel cell stack housing.

33. The interconnect of claim 32, further comprising a catalyst layer disposed on the heat transfer appendages.

34. The interconnect of claim 31, wherein the housing further comprises a plurality of tabs configured to secure a plurality of catalyst.

35. The interconnect of claim 29, further comprising a thermowell.

36. The interconnect of claim 29, further comprising at least one exhaust aperture.

37. The interconnect of claim 31, further comprising a shield disposed between the fuel cell processor and the fuel cell stack.

38. A engine block, comprising:
a fuel cell stack having at least one fuel inlet;
a fuel processor in fluid communication with the fuel cell stack, the fuel processor having at least one fuel inlet;
at least one fuel cell heater coupled to the fuel cell stack;
at least one thermocouple coupled to the fuel cell stack or the fuel processor; and
at least one power input/output leads coupled to the engine block.

39. The engine block of claim 38, where in the fuel cell stack and fuel processor operate at a temperature differential less than 150° C.

40. The engine block of claim 38, wherein the fuel cell stack and fuel processor operate at substantially the same temperature.

41. The engine block of claim 38, further comprising at least one gas composition sensor.

42. The engine block of claim 38, further comprising a thermal insulator around the fuel cell stack and the fuel processor.

43. The engine block of claim 38, further comprising a thermal insulator around the fuel cell stack, the fuel processor, and the at least one fuel cell heater.
